(19) United States
(12) Patent Application Publication
(10) Pub. No.: US 2018/0335177 A1
(43) Pub. Date: Nov. 22, 2018

(54) ADJUSTABLE HUB AND APPARATUS FOR SUPPORTING ONE OR MORE ITEMS ONTO A STAND

(71) Applicant: THE 3D WAY INCORPORATED, Scarborough (CA)

(72) Inventor: William BLACK, Scarborough (CA)

(21) Appl. No.: 15/982,058

(22) Filed: May 17, 2018

Related U.S. Application Data
(60) Provisional application No. 62/507,887, filed on May 18, 2017.
(60) Provisional application No. 62/568,360, filed on Oct. 5, 2017.

(51) Int. Cl. F16M 13/00; F16M 13/02; F16M 11/16

(52) U.S. Cl. CPC F16M 13/005; F16M 13/02; F16M 2200/08; F16M 2200/028; F16M 2200/024; F16M 11/16

(57) ABSTRACT

There is provided a hub, mountable accessory and apparatus for supporting one or more items onto a stand. The apparatus includes: a hub mountable to the pole, the hub including a central member defining a central channel for receiving the pole, the central member defining one or more mounting slots on a periphery of the central member; and one or more mountable accessories mountable to the hub, each of the one or more mountable accessories including a support, for supporting one or more of the items, and a complementary mounting post affixed to the support, the complementary mounting post dimensioned to be slid into a respective one of the mounting slots.

### TECHNICAL FIELD

The present disclosure relates generally to accessories for musicians; and more specifically to an adjustable hub for supporting one or more items onto a stand.

### BACKGROUND

Due to the nature of holding an object, playing an instrument, or interacting with an audience, often times a person, such as a photographer or musician, does not have hands available to hold various items. Accordingly, such people will often use a stand to aid them while they are doing another task, such as while a musician is playing or performing. As an example, musicians can use: music stands to hold and display their charts while they are playing; microphone stands to hold and position a microphone; instrument stands to hold their instrument when they are not using it; keyboard stands to hold one or more keyboards in a playing position; drum stands to hold the various parts of a drum kit in position (for example, cymbals, hi-hat, snare, toms, or the like); speaker stands to mount a speaker in position; light stands to hold stage lighting in position; or the like.

For the example of microphone stands, such stands typically include a base, a microphone holder, and a pole intermediate the base and the microphone holder. In some cases, the pole can be adjustable in height to bring the microphone holder to mouth level of the musician. Microphone stands are particularly advantageous for musicians that sing while also playing an instrument or accomplishing another task. At times, the musician may also require other items or accessories to be accessible or viewable along with the microphone that the musician is not able to hold with his or her hands. In conventional approaches, this can cause performance stages or rehearsal spaces to become disorganized and crowded by the other items and accessories strewn around the musician.

It is therefore an object of the present invention to provide an adjustable hub in which the above disadvantages are obviated or mitigated and attainment of the desirable attributes is facilitated.

### SUMMARY

In an aspect, there is provided an apparatus for supporting one or more items onto a stand, the stand comprising a pole, the apparatus comprising: a hub mountable to the pole, the hub comprising a central member defining a central channel for receiving the pole, the central member defining one or more mounting slots on a periphery of the central member; and one or more mountable accessories mountable to the hub, each of the one or more mountable accessories comprising a support, for supporting one or more of the items, and a complementary mounting post affixed to the support, the complementary mounting post dimensioned to be slid into a respective one of the mounting slots.

In a further case, the hub is mounted to the pole via openings in the central member to allow the pole access to the central channel.

In another case, the central member defines a transverse opening, upper opening, and lower opening, and wherein the hub is configured to mount on the pole by passing the pole into the transverse opening and rotating the hub such that the pole passes through the upper opening and lower opening into the central channel.

In yet another case, the transverse opening is from the central channel to the periphery of the central member, an axis of the transverse opening being transverse to the central channel, the upper opening is from the central channel to the periphery of the central member, the upper opening extending from the transverse opening to a top end of the central member, and the lower opening is from the central channel to the periphery of the central member, the lower opening extending from the transverse opening to a bottom end of the central member, access to the lower opening being approximately 180 degrees circumferentially from the upper opening and approximately 90 degrees circumferentially from the transverse opening.

In yet another case, the transition from the central channel to the upper opening, lower opening, or both, is tapered for snapping the pole into the central channel.

In yet another case, the hub comprises a first opposing portion pivotally connected to a second opposing portion for closeably exposing the central channel to receive the pole.

In yet another case, the hub comprises a slidable locking pin for closing the first opposing portion to the second opposing portion opposite the pivot.

In yet another case, the hub comprises a tightening fastener in mechanical communication with a ram located in the central channel for adjustably securing the hub to the pole.

In yet another case, the hub further comprising a fastener fastenable across the upper opening, the lower opening, or both.

In yet another case, wherein the fastener is rotatable away from the respective opening.

In yet another case, the support is selected from a group consisting of an instrument support, a support tray, a display support, a slotted support, and a cupped support.

In another aspect, there is provided a hub for supporting one or more items onto a stand with one or more mountable accessories, each of the one or more mountable accessories comprising a complementary mounting post affixed to a support, the stand comprising a pole, the hub comprising: a central member defining a central channel for receiving the pole to mount the hub to the pole; and one or more mounting slots defined by the central member and located on a periphery of the central member, each of the one or more mounting slots dimensioned to slide a respective one of the complementary mounting posts therein.

In a further case, the hub is mounted to the pole via openings in the central member to allow the pole access to the central channel.

In another case, the central member defines a transverse opening, upper opening, and lower opening, and wherein the hub is configured to mount on the pole by passing the pole into the transverse opening and rotating the hub such that the pole passes through the upper opening and lower opening into the central channel.

In yet another case, the transverse opening is from the central channel to the periphery of the central member, an axis of the transverse opening being transverse to the central channel, the upper opening is from the central channel to the periphery of the central member, the upper opening extending from the transverse opening to a top end of the central member, and the lower opening is from the central channel to the periphery of the central member, the lower opening extending from the transverse opening to a bottom end of the central member, access to the lower opening being approximately 180 degrees circumferentially from the upper opening and approximately 90 degrees circumferentially from the transverse opening.

In yet another case, the transition from the central channel to the upper opening, lower opening, or both, is tapered for snapping the pole into the central channel.

In yet another case, the hub further comprising a fastener fastenable across the upper opening, the lower opening, or both.

In yet another case, the fastener is rotatable away from the respective opening.

In yet another case, the complementary mounting post and the mounting slot have a substantially circular cross-section.

In yet another case, the central member defines a plurality of mounting slots.

In yet another case, the plurality of mounting slots are spaced annularly around the periphery of the central member.

In another aspect, there is provided a mountable accessory for supporting one or more items onto a stand with a hub, the stand comprising a pole, the hub mountable to the pole, the hub comprising a central member defining one or more mounting slots on a periphery of the central member, the mountable accessory comprising: a support, for supporting one or more of the items; and a complementary mounting post affixed to a rear of the support, the complementary mounting post dimensioned to be slid into a respective one of the mounting slots.

In a further case, the support is selected from a group consisting of an instrument support, a support tray, a display support, a slotted support, and a cupped support.

These and other aspects are contemplated and described herein. It will be appreciated that the foregoing summary sets out representative aspects of the embodiments to assist skilled readers in understanding the following detailed description. It is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

### DESCRIPTION OF THE DRAWINGS

A greater understanding of the embodiments will be had with reference to the Figures, in which:

FIG. 1 is a side view of an exemplary collar for mounting accessories;

FIG. 2A is a front perspective view of a hub for supporting one or more items onto a stand, according to an embodiment;

FIG. 2B is a rear perspective view of the hub of FIG. 2A;

FIG. 2C is a top view of the hub of FIG. 2A;

FIG. 2D is a front view of the hub of FIG. 2A;

FIG. 2E is a side view of the hub of FIG. 2A;

FIG. 3A is a front perspective view of a hub for supporting one or more items onto a stand, according to another embodiment;

FIG. 3B is a rear perspective view of the hub of FIG. 3A;

FIG. 3C is a top view of the hub of FIG. 3A;

FIG. 3D is a front view of the hub of FIG. 3A;

FIG. 3E is a side view of the hub of FIG. 3A;

FIG. 4A is a perspective view of a hub for supporting one or more items onto a stand, according to yet another embodiment;

FIG. 4B is a top view of the hub of FIG. 4A;

FIG. 5A is a perspective view of a hub for supporting one or more items onto a stand, according to yet another embodiment;

FIG. 5B is a top view of the hub of FIG. 5A;

FIG. 6A is a perspective view of a mountable accessory being an instrument support, according to an embodiment;

FIG. 6B is a side view of the mountable accessory of FIG. 6A;

FIG. 6C is a top view of the mountable accessory of FIG. 6A;

FIG. 7A is a perspective view of a mountable accessory being a support tray, according to an embodiment;

FIG. 7B is a side view of the mountable accessory of FIG. 7A;

FIG. 7C is a top view of the mountable accessory of FIG. 7A;

FIG. 8A is a perspective view of a mountable accessory being a display support, according to an embodiment;

FIG. 8B is a side view of the mountable accessory of FIG. 8A;

FIG. 8C is a top view of the mountable accessory of FIG. 8A;

FIG. 9A is a perspective view of a mountable accessory being a slotted support, according to an embodiment;

FIG. 9B is a side view of the mountable accessory of FIG. 9A;

FIG. 9C is a top view of the mountable accessory of FIG. 9A;

FIG. 10A is a perspective view of a mountable accessory being a support tray, according to another embodiment;

FIG. 10B is a side view of the mountable accessory of FIG. 10A;

FIG. 10C is a top view of the mountable accessory of FIG. 10A;

FIG. 11A is a perspective view of a mountable accessory being a cupped support, according to an embodiment;

FIG. 11B is a side view of the mountable accessory of FIG. 11A;

FIG. 11C is a top view of the mountable accessory of FIG. 11A;

FIG. 12 is a perspective view of a mountable accessory being a cupped support, according to another embodiment;

FIG. 13 is a perspective view of a mountable accessory being a cupped support, according to yet another embodiment;

FIG. 14 is a perspective view of a mountable accessory being a cupped support, according to yet another embodiment;

FIG. 15A is a perspective view of the hub of FIG. 3A mounted on a stand in an initial position;

FIG. 15B is a side view of the hub of FIG. 15A;

FIG. 15C is a top view of the hub of FIG. 15A;

FIG. 16A is a perspective view of the hub of FIG. 3A mounted on a stand in an intermediary position;

FIG. 16B is a side view of the hub of FIG. 16A;

FIG. 16C is a top view of the hub of FIG. 16A;

FIG. 17A is a perspective view of the hub of FIG. 3A mounted on a stand in a mounted position;

FIG. 17B is a side view of the hub of FIG. 17A;

FIG. 17C is a top view of the hub of FIG. 17A;

FIG. 18A is a perspective view of a hub for supporting one or more items onto a stand, according to yet another embodiment;

FIG. 18B is a front view of the hub of FIG. 18A;

FIG. 18C is a side view of the hub of FIG. 18A;

FIG. 19A is a perspective view of the hub of FIG. 18A with two mountable accessories mounted thereon;

FIG. 19B is a side view of the hub of FIG. 19A;

FIG. 19C is a top view of the hub of FIG. 19A;

FIG. 20A is a perspective view of the hub of FIG. 5A with four mountable accessories mounted thereon;

FIG. 20B is a side view of the hub of FIG. 20A;

FIG. 21 is a schematic diagram of an apparatus for supporting one or more items onto a stand;

FIG. 22A is a partial top view of the hub of FIG. 2A showing a dimensional taper;

FIG. 22B is a perspective view of the hub of FIG. 22A;

FIG. 23A is a perspective view of a hub for supporting one or more items onto a stand, according to yet another embodiment;

FIG. 23B is a top view of the hub of FIG. 23A;

FIG. 24A is a front perspective view of a hub for supporting one or more items onto a stand, in closed configuration, according to yet another embodiment;

FIG. 24B is a front view of the hub of FIG. 24A;

FIG. 24C is a top view of the hub of FIG. 24A;

FIG. 24D is a side view of the hub of FIG. 24A;

FIG. 24E is a further top view of the hub of FIG. 24A;

FIG. 24F is a further perspective view of the hub of FIG. 24A;

FIG. 24G is a front perspective view of the hub of FIG. 24A in open configuration;

FIG. 24H is a front view of the hub of FIG. 24G;

FIG. 24J is a top view of the hub of FIG. 24G;

FIG. 24K is a side view of the hub of FIG. 24G;

FIG. 24L is a further top view of the hub of FIG. 24G;

FIG. 24M is a further perspective view of the hub of FIG. 24G;

FIG. 24N is a further front view of the hub of FIG. 24A;

FIG. 24P is a further side view of the hub of FIG. 24A;

FIG. 25A is a perspective view of a mountable accessory being a display support, according to another embodiment;

FIG. 25B is a side view of the mountable accessory of FIG. 25A;

FIG. 26A is a perspective view of a mountable accessory being a support tray, according to another embodiment;

FIG. 26B is a side view of the mountable accessory of FIG. 26A;

FIG. 27A is a perspective view of a lid for a support tray, according to an embodiment;

FIG. 27B is a side view of the lid of FIG. 26A;

FIG. 28A is a perspective view of removable adapters, according to an embodiment;

FIG. 28B is a side view of the removable adapters of FIG. 28A;

FIG. 28C is a side view of the removable adapters of FIG. 28A, mounted on a support tray and holding a tablet for display;

FIG. 29A is a top perspective view of a hub for supporting one or more items onto a stand, according to yet another embodiment, shown in a in a closed configuration;

FIG. 29B is a top view of the hub of FIG. 29A;

FIG. 29C is a top perspective view of the hub of FIG. 29A taken from an opposite side of that of FIG. 29A;

FIG. 29D is a side view of the hub of FIG. 29A;

FIG. 29E is a side view of the hub of FIG. 29A taken from a 90° angle to that of FIG. 29D;

FIG. 29F is a side view of the hub of FIG. 29A taken from an opposing side of the hub of that of FIG. 29D;

FIG. 29G is a bottom perspective view of the hub of FIG. 29A;

FIG. 29H is a bottom view of the hub of FIG. 29A;

FIG. 29I is a bottom perspective view of the hub of FIG. 29A taken from an opposite side of that of FIG. 29G;

FIG. 30A is a top perspective view of the hub of FIG. 29A showing the latch is in a pushed down open position such that the hub's locking side can be placed into an open configuration;

FIG. 30B is a top view of the hub of FIG. 30A;

FIG. 30C is a top perspective view of the hub of FIG. 30A taken from an opposite side of that of FIG. 30A;

FIG. 30D is a side view of the hub of FIG. 30A;

FIG. 30E is a side view of the hub of FIG. 30A taken from a 90° angle to that of FIG. 30D;

FIG. 30F is a side view of the hub of FIG. 30A taken from an opposing side of the hub of that of FIG. 30D;

FIG. 30G is a bottom perspective view of the hub of FIG. 30A;

FIG. 30H is a bottom view of the hub of FIG. 30A;

FIG. 30I is a bottom perspective view of the hub of FIG. 30A taken from an opposite side of that of FIG. 30G;

FIG. 31A is a top perspective view of the hub of FIG. 29A showing a stand shaft disposed therein, with the hub in a locked closed position and ram tightened, forcing the shaft into a locked closed configuration;

FIG. 31B is a top view of the hub of FIG. 31A;

FIG. 31C is a top perspective view of the hub of FIG. 31A taken from an opposite side of that of FIG. 31A;

FIG. 31D is a side view of the hub of FIG. 31A;

FIG. 31E is a side view of the hub of FIG. 31A taken from a 90° angle to that of FIG. 31D;

FIG. 31F is a side view of the hub of FIG. 31A taken from an opposing side of the hub of that of FIG. 31D;

FIG. 31G is a bottom perspective view of the hub of FIG. 31A;

FIG. 31H is a bottom view of the hub of FIG. 31A;

FIG. 31I is a bottom perspective view of the hub of FIG. 31A taken from an opposite side of that of FIG. 31G;

FIG. 32A is a top perspective view of the hub of FIG. 29A shown in an open configuration;

FIG. 32B is a top view of the hub of FIG. 32A;

FIG. 32C is a top perspective view of the hub of FIG. 32A taken from an opposite side of that of FIG. 32A;

FIG. 32D is a side view of the hub of FIG. 32A;

FIG. 32E is a side view of the hub of FIG. 32A taken from a 90° angle to that of FIG. 32D;

FIG. 32F is a side view of the hub of FIG. 32A taken from an opposing side of the hub of that of FIG. 32D;

FIG. 32G is a bottom perspective view of the hub of FIG. 32A;

FIG. 32H is a bottom view of the hub of FIG. 32A;

FIG. 32I is a bottom perspective view of the hub of FIG. 32A taken from an opposite side of that of FIG. 32G;

FIG. 33A is a top perspective view of an exemplary accessory mountable to the hub of FIG. 29A and a closeup view of the mounting key thereof;

FIG. 33B is a top view of the accessory of FIG. 33A and a closeup view of the mounting key thereof;

FIG. 33C is a rear view of the accessory of FIG. 33A and a closeup view of the mounting key thereof;

FIG. 33D is a side view of the accessory of FIG. 33A and a closeup view of the mounting key thereof;

FIG. 33E is a bottom perspective view of the accessory of FIG. 33A and a closeup view of the mounting key thereof; and

FIG. 33F is a bottom view of the accessory of FIG. 33A and a closeup view of the mounting key thereof.

### DETAILED DESCRIPTION

For simplicity and clarity of illustration, where considered appropriate, reference numerals may be repeated among the Figures to indicate corresponding or analogous elements. In addition, numerous specific details are set forth in order to provide a thorough understanding of the embodiments described herein. However, it will be understood by those of ordinary skill in the art that the embodiments described herein may be practised without these specific details. In other instances, well-known methods, procedures and components have not been described in detail so as not to obscure the embodiments described herein. Also, the description is not to be considered as limiting the scope of the embodiments described herein.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description.

The present disclosure relates generally to accessories for musicians; and more specifically to an adjustable hub for supporting one or more items onto a stand.

For the purposes of the following disclosure, a stand can include any stand used to support an object via a pole. In an example, the stand can include a musician stand used in a performance, rehearsal, playing of an instrument, stage apparatus, or venue mechanism. The musician stand can include, for example, music stands, tablet stand, microphone stand, instrument stand, keyboard stand, drum stand, cymbal stand, speaker stand, lighting stand, or the like. In another example, the stand can include a photography stand used to support a camera, lighting, backdrop, or the like. However, it will be appreciate by the reader that the stand could be any pole, bar or rod that is adaptable to receive the adjustable hub as herein described.

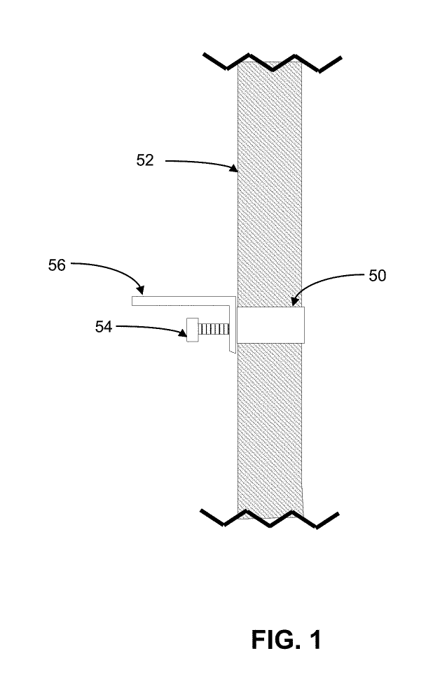

As shown in FIG. 1, in an example of an approach to mounting accessories to a stand, the musician can use an annular, or partially annular, collar 50 that clamps onto a pole 52 of the stand. In this case, there is also a screw fastener 54 that secures a mounting element 56 to the collar 50, and the collar 50 to the pole 52. The distal end of the screw fastener 54 abuts the pole 52 causing the collar 50 to be locked into place. The collar 50 clamp mechanism can mount only one item at a time per collar 50; therefore, each separate item requires a separate collar 50 individually positioned on the pole 52. Accordingly, these collars 50 when used in aggregate to hold accessories, collectively take up a large amount of space along the pole 52. Aesthetically, this approach may not be visually appealing to a musical performance. Additionally, this approach may require the musician to have to reach various locations on the microphone stand to access the various accessories. This approach can also damage the pole 52 due to the fastening of the screw fastener 54. In addition, this approach can add substantial weight to the stand possibly causing instability and center balance issues.

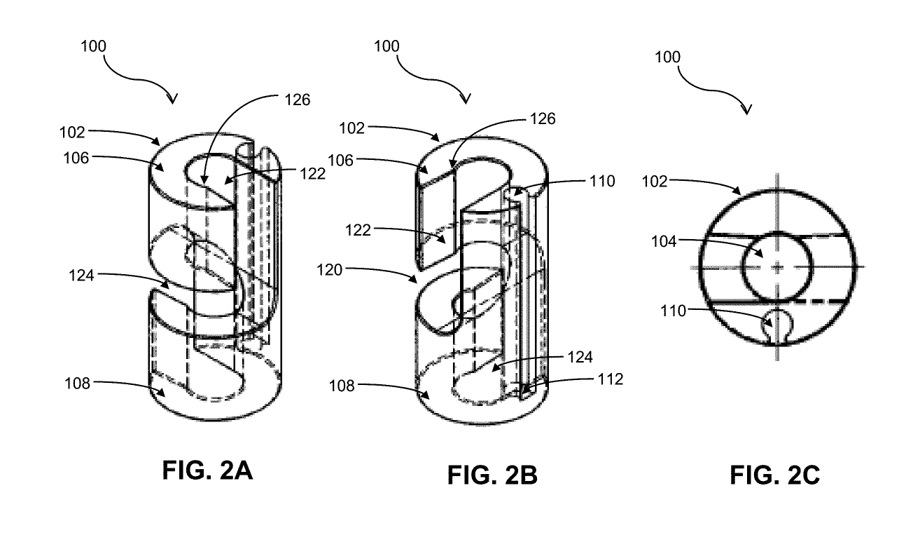

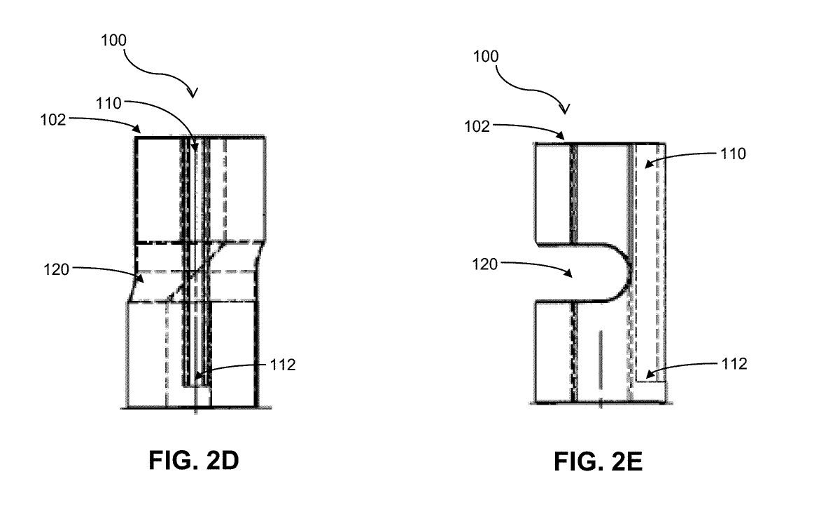

FIGS. 2A to 2E illustrate a hub 100, according to an embodiment, for mounting of musician's accessories thereto. The hub 100 includes a central member 102. As best shown in FIG. 2C, the central member 102 defines a central channel 104 therethrough from a top end 106 to a bottom end 108 of the central member 102. The central member 102 also includes one or more mounting slots 110. As described herein, the one or more mounting slots 110 are used to mount accessories to the hub 100. In the embodiment of FIGS. 2A to 2E, the central member 102 includes one mounting slot 110. The one or more mounting slots 110 are located with an opening on the periphery of the central member 102. The length of the one or more mounting slots 110 is less than the height of the central member 102 such that there is a lower abutment 112 at the bottom of each of the mounting slots 110. In the embodiment of FIGS. 2A to 2E, the one or more mounting slots 110 have a substantially circular periphery; however, in further embodiments, any suitable peripheral shape can be used, including, for example, square, rectangular, triangular, or the like. In addition, while in the embodiment of FIGS. 2A to 2E, the one or more mounting slots 110 are parallel to the direction of the height of the central member 102, in other embodiments the one or more mounting slots 110 can be angled relative to the height direction.

In the embodiment of FIGS. 2A to 2E, the hub 100 can be mounted to the pole 52 of the stand using a ‘twist-on’ mechanism. In this case, the central member 102 defines a transverse opening 120, best shown in FIG. 2E, located at a point in between the top end 106 and bottom end 108. The transverse opening 120 is dimensioned to fit the pole 52 therein. The depth of the transverse opening 120 is such that the transverse opening 120 ends approximately at the far side of the central channel 120. The central member 102 also defines an upper opening 122 and a lower opening 124. The upper and lower openings 122, 124 extend from the periphery of the central member 102 to the central channel 104. The length of the upper opening 122 extends from the top end 106 to the transverse opening 120, and the length of the lower opening 124 extends from the transverse opening 120 to the bottom end 108. The upper opening 122 is located on the central member 102 approximately 180 degrees circumferentially from the lower opening 124 and approximately 90 degrees circumferentially from the transverse opening 120. In some cases, the transition from the transverse opening 120 to the central channel 104 can be gradual and/or sloped.

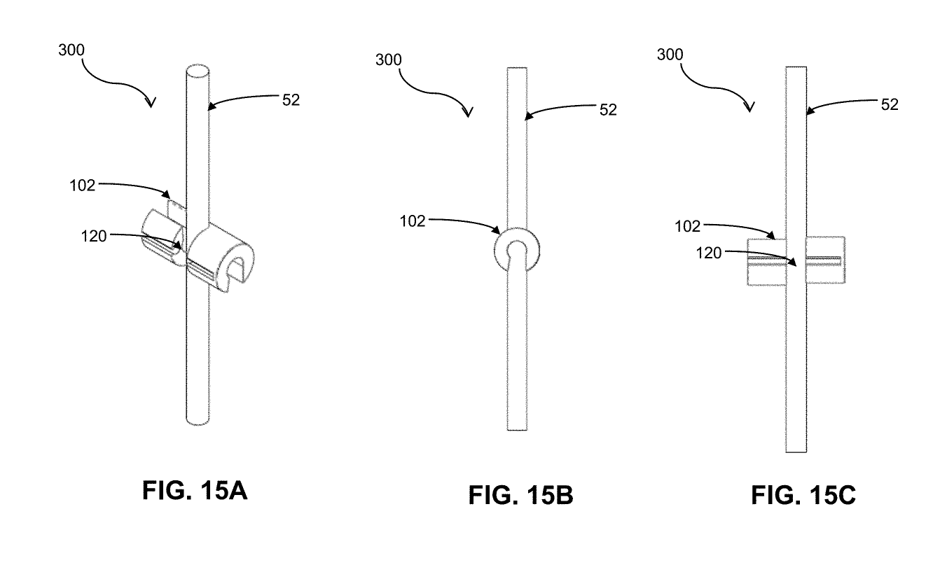

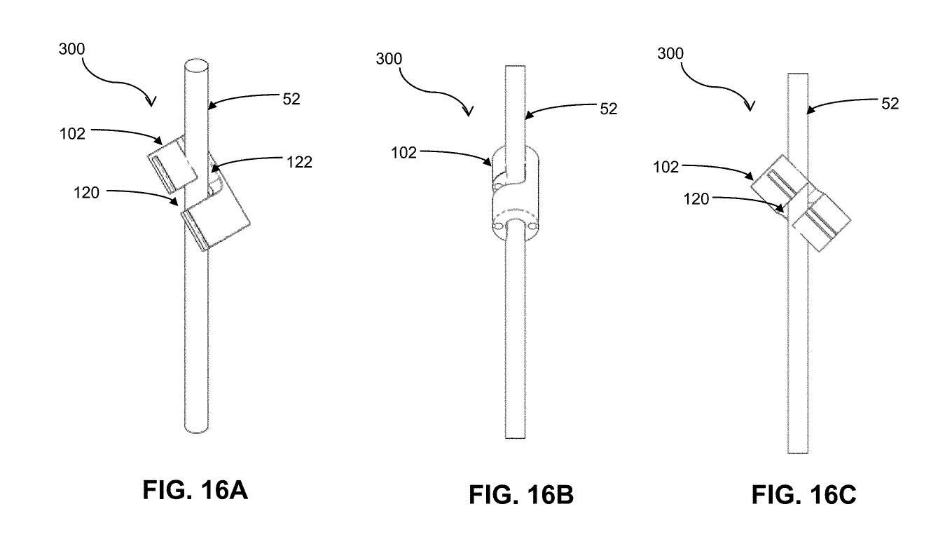

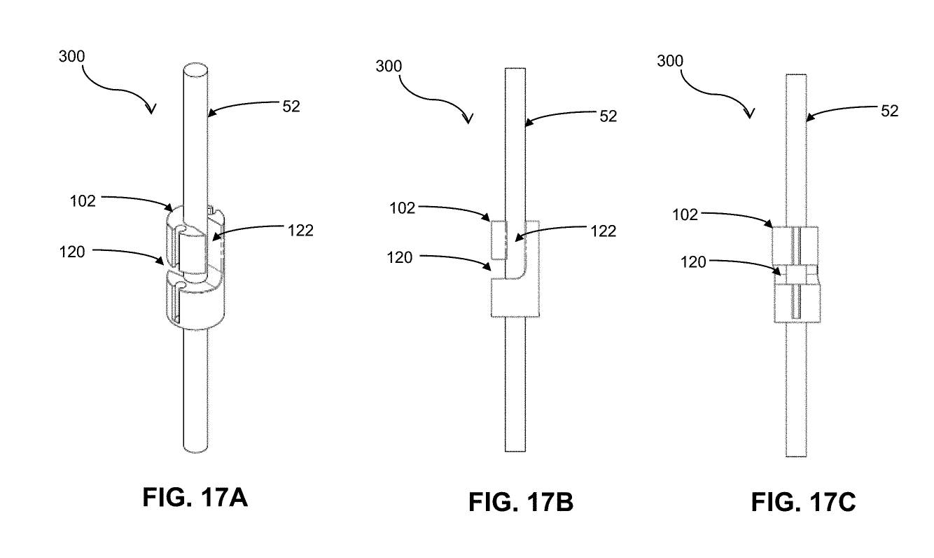

As shown in FIGS. 15A to 15C, the hub 100 is mounted on the pole 52 using a ‘twist-on’ mechanism by first inserting the pole 52 all the way into the transverse opening 120. As shown in FIGS. 16A to 16C, the central member 102 is then rotated, bringing the top end 106 upwards towards the pole 52 and the bottom end 108 downwards towards the pole 52. As shown in FIGS. 17A to 17C, rotation is continued until the pole 52 is located in the central channel 104, the hub 100 being coaxial with the pole 52. In this orientation, the hub 100 is ready to have one or more attachments mounted thereon, as described herein.

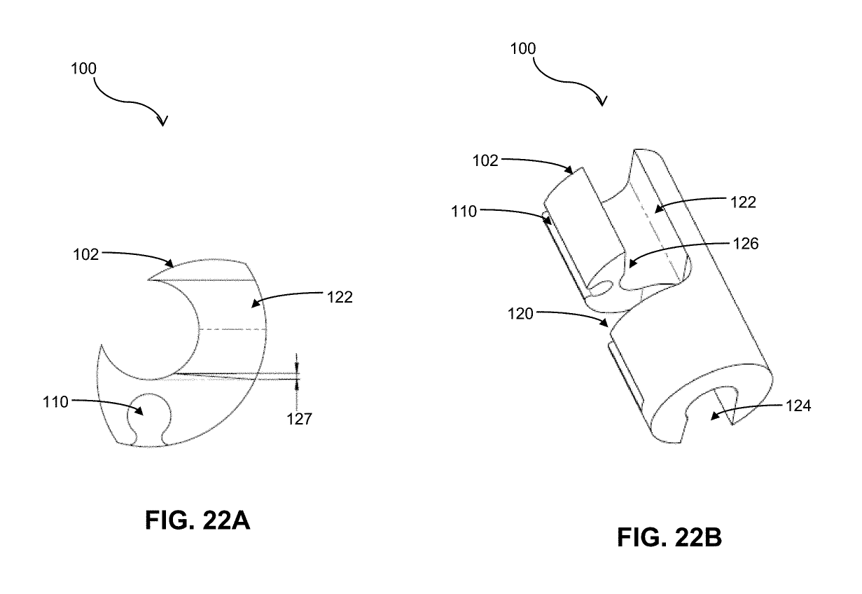

In a particular case, the top and lower openings 122, 124 are slightly smaller than the diameter of the central channel 104. Thus, there is a taper 127 creating a ridge 126 for snapping the pole 52 into the central channel 104, helping lock and hold the hub 100 in place around the pole 52 and preventing the hub 100 from moving in the direction of the openings 122, 124. As exemplified in FIGS. 22A and 22B, there is a dimensional taper 127 towards the center of the central member 102, for example, of approximately 0.040 inches.

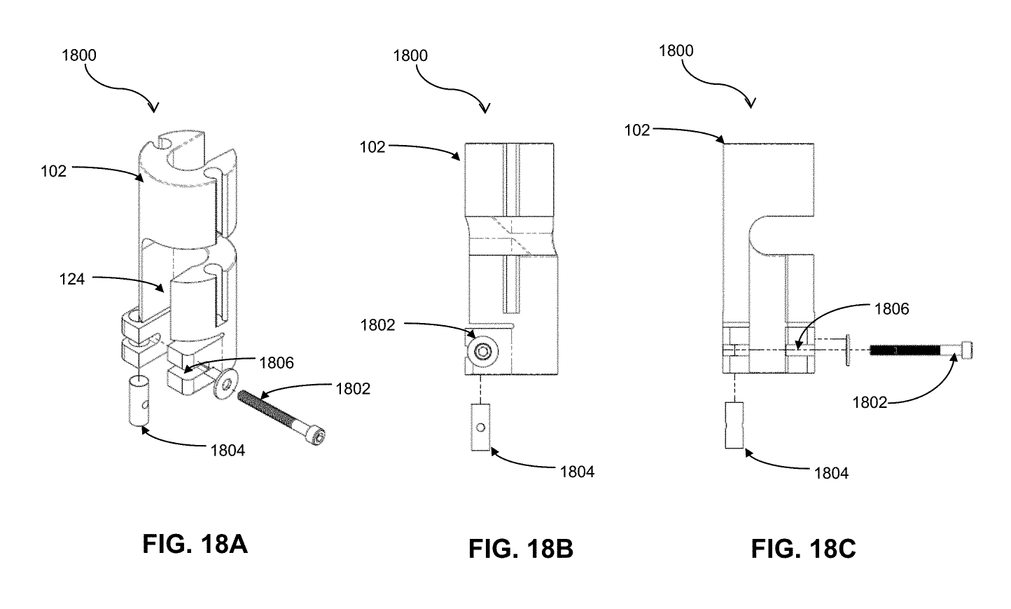

In this embodiment, the frictional forces of the central channel 104 against the pole 52 secure the mounting of the hub 100 in place on the pole 52. In further embodiments, one or more fasteners may be used to help secure the hub 100 to the pole 52. As an example, a hub 1800, as shown in FIGS. 18A to 18C, has one or more threaded posts 1802 that may be configured to span the upper opening 122, the lower opening 124, or both. When the threaded post 1802 is tightened, it causes the two sides of the opening 122, 124 to be drawn together, thus increasing the frictional forces on the pole 52. For insertion or removal of the pole 52 from the hub 100, each threaded post can be removed or rotated out of the way of the openings 122, 124. In the case of FIGS. 18A to 18C, the threaded post 1802 is received by a rotatable member 1804, which is configured to rotate the threaded post 1802 into and out of a fastening slot 1806 in the central member 102. The rotatable member 1804 is located in and rotatable relative to the central member 102. In further cases, the central channel 104 can include other features to increase the frictional forces against the pole 52; for example, ridges defined on the channel, a tapering channel cross-section, a high-friction material lining the channel, or the like.

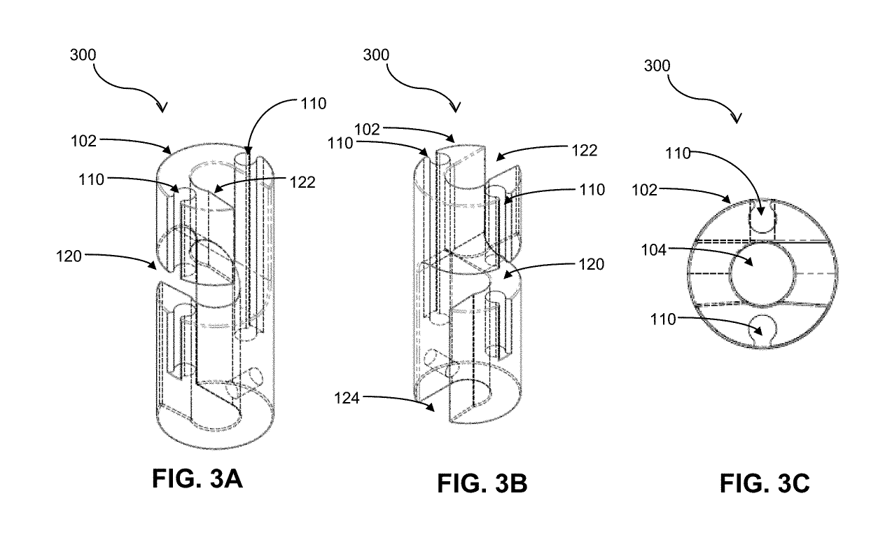

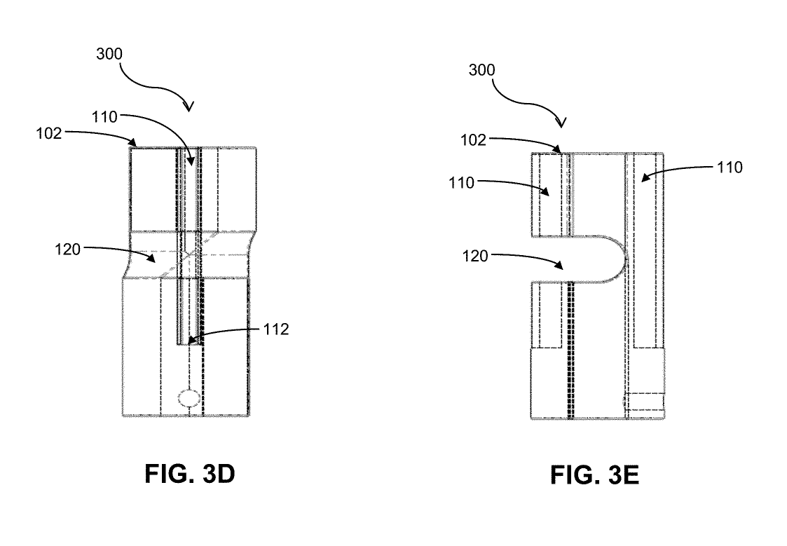

FIGS. 3A to 3E illustrate another embodiment of a hub 300. In this embodiment, there are two opposed mounting slots 110. In this example, one of the mounting slots 110 can span either side of the transverse opening 120, as best shown in FIG. 3E.

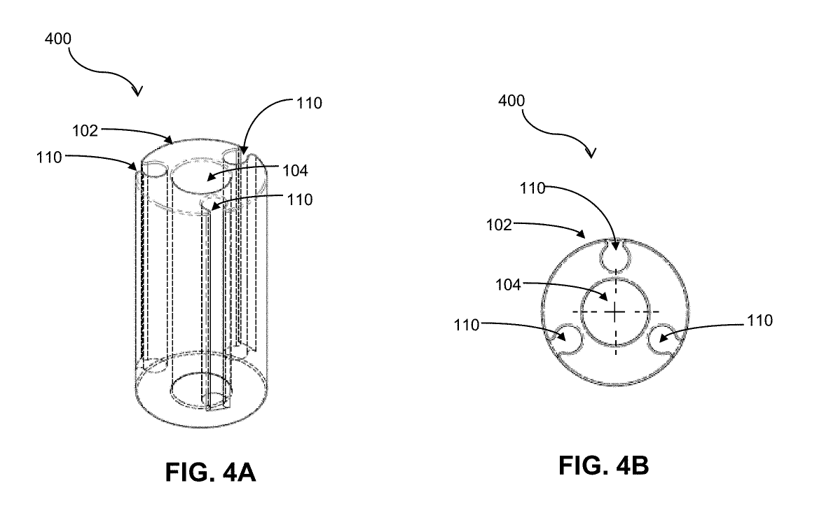

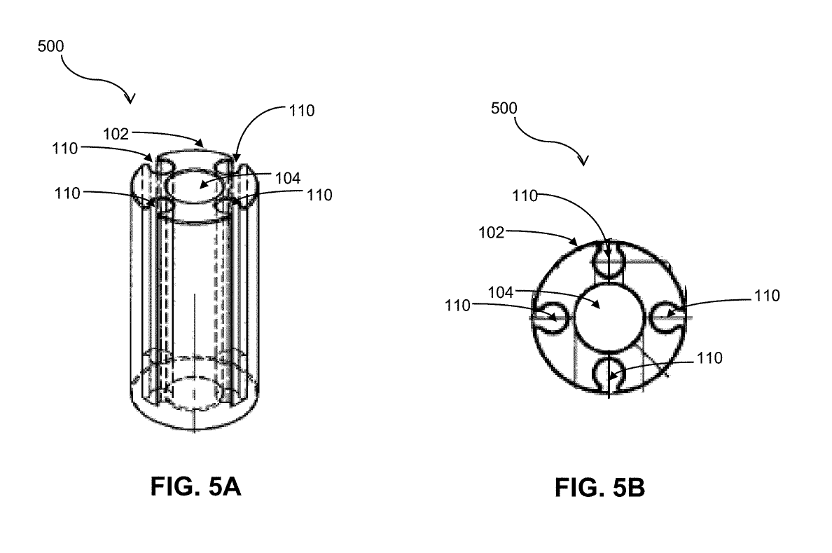

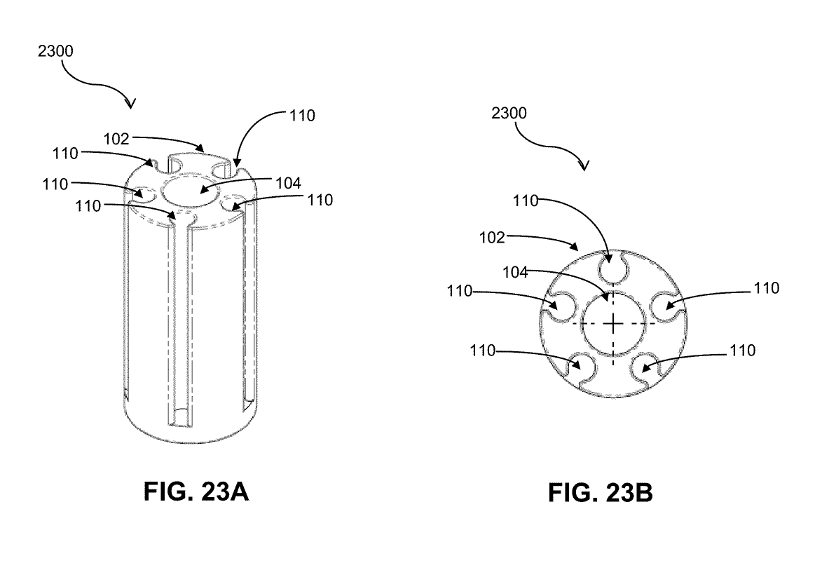

FIGS. 4A and 4B illustrate another embodiment of a hub 400. In this embodiment, there are three mounting slots 110 spaced annularly around the periphery of the central member 102. FIGS. 5A and 5B illustrate another embodiment of a hub 500. In this embodiment, there are four mounting slots 110 spaced annularly around the periphery of the central member 102. FIGS. 23A and 23B illustrate another embodiment of a hub 2300. In this embodiment, there are five mounting slots 110 spaced annularly around the periphery of the central member 102. While in the above embodiments, the mounting slots 110 are spaced evenly around the periphery, in further embodiments, the mounting slots 110 can be spaced any suitable distance from one another. In the embodiments of FIGS. 4A, 4B, 5A, and 5B, the hub 400, 500, 2300 does not include the ‘twist-on’ mechanism described above. Instead, these embodiments can be slid down from the top of the pole 52 to the proper position. The hub 400, 500, 2300 can be secured in place by frictional forces against the pole 52 or by a fastener. While hub 400, 500, 2300 do not include the ‘twist-on’ mechanism described above, such embodiments are not intended to be limiting on the number of mounting slots 100 of a hub using the ‘twist-on’ mechanism, which can include three or more mounting slots 110.

In a further case, the central member 102 can be comprised of two opposing pieces rotatably connected by a hinge. In this case, the central member 102 can be opened by rotating the opposed pieces apart, along the hinge, exposing the central channel 104. The pole 52 can be received by the central channel 104, and the central member 102 can be closed by rotating in the opposing pieces along the hinge in the opposite direction. A fastener can then be fastened, locking the central member 102 in place around the pole 52. The fastener can be, for example, the threaded post 1802 described above.

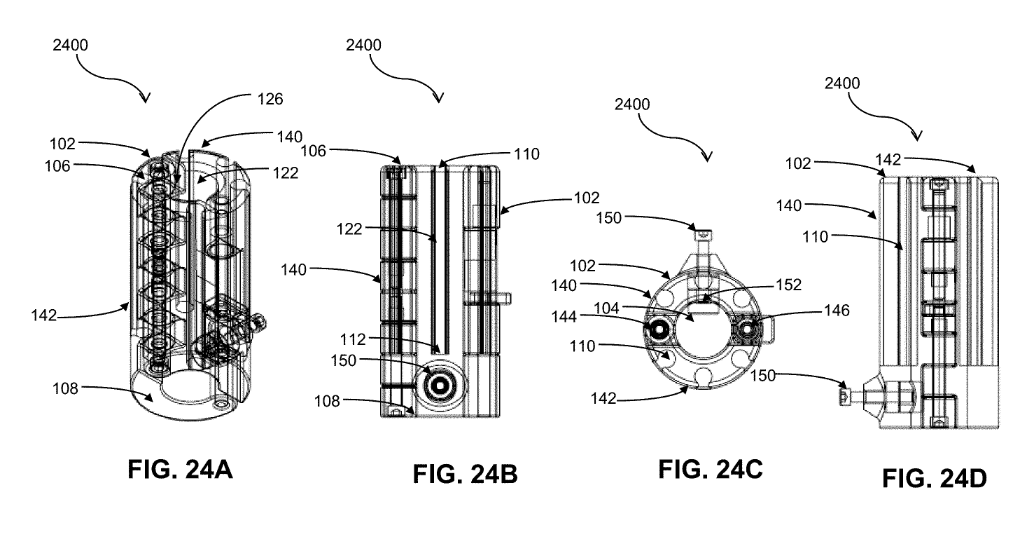

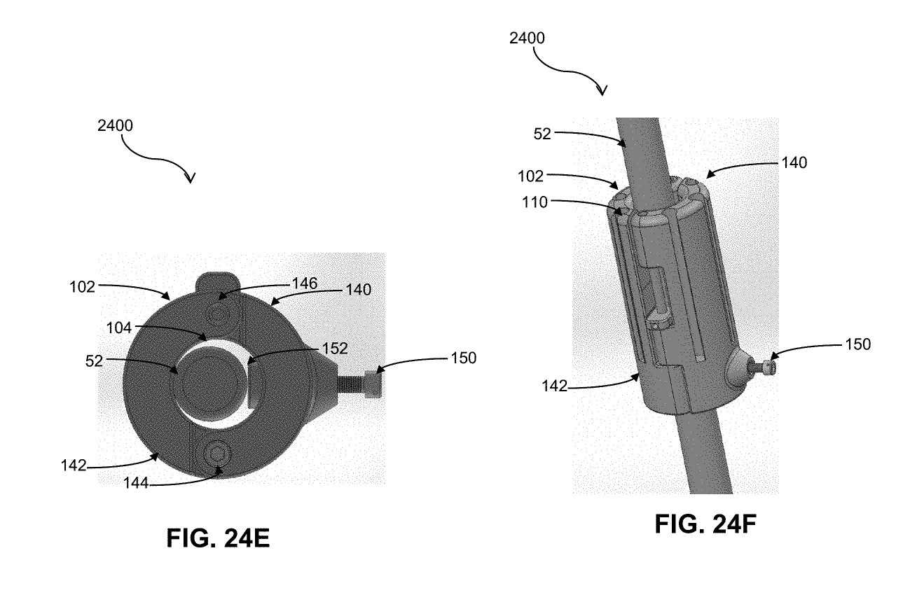

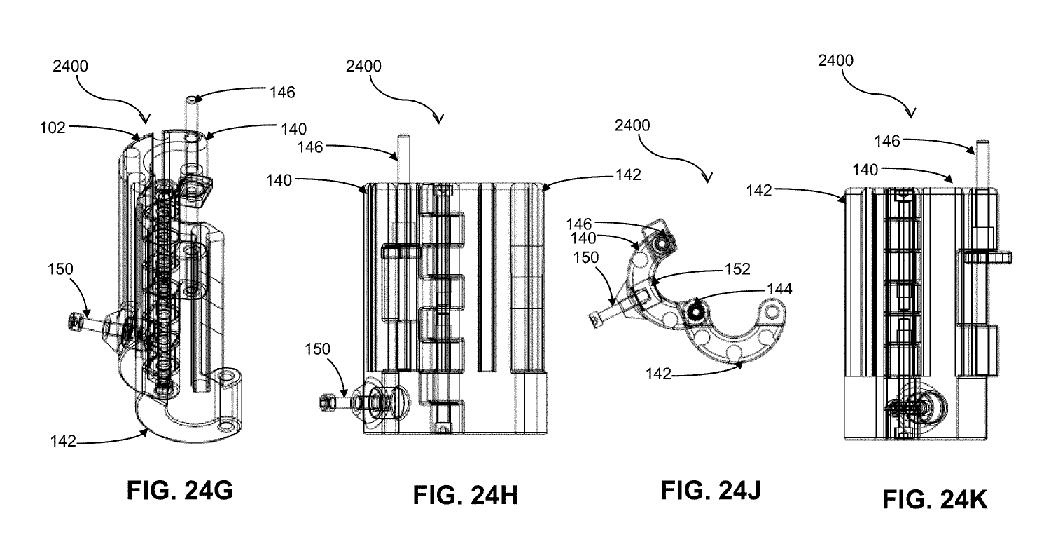

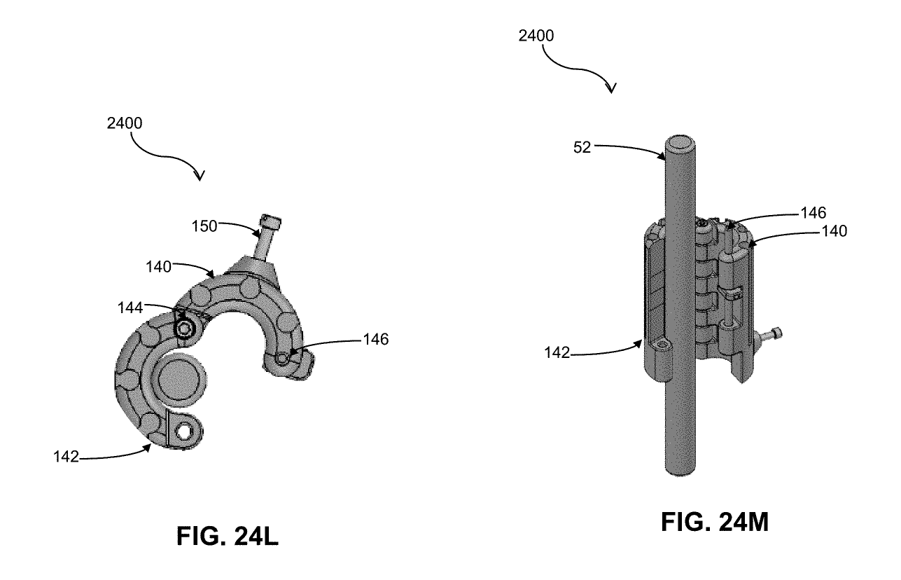

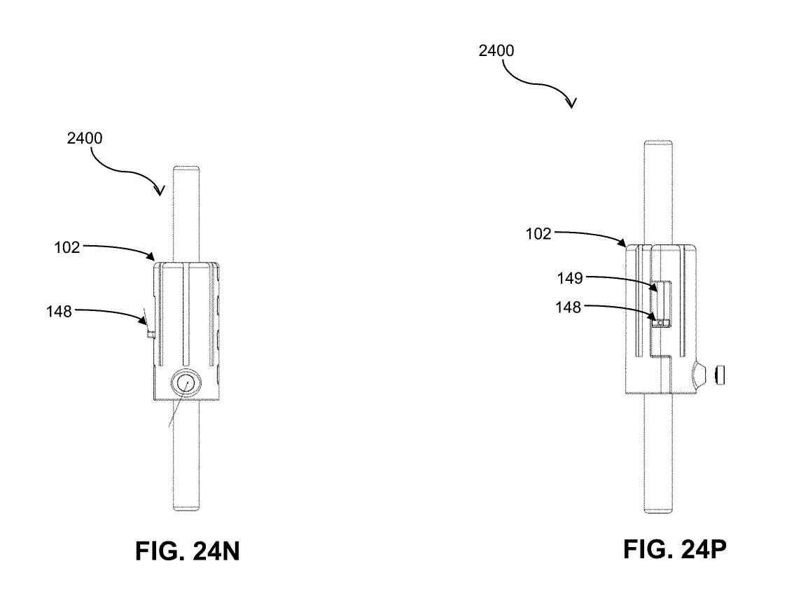

FIGS. 24A to 24P illustrate another embodiment of a hub 2400 for mounting of musician's accessories thereto. In this embodiment, the hub 2400 includes a central member 102. As best shown in FIG. 24C, the central member 102 defines a central channel 104 therethrough from a top end 106 to a bottom end 108 of the central member 102 for receiving a pole 52. The central member 102 also includes one or more mounting slots 110; in the example shown in FIG. 24C, there are six distinct mounting slots 110. As described herein, the one or more mounting slots 110 are used to mount accessories to the hub 2400. In the embodiment of FIGS. 2A to 2E, the central member 102 includes one mounting slot 110. The one or more mounting slots 110 are located with an opening on the periphery of the central member 102. The length of the one or more mounting slots 110 is less than the height of the central member 102 such that there is a lower abutment 112 at the bottom of each of the mounting slots 110.

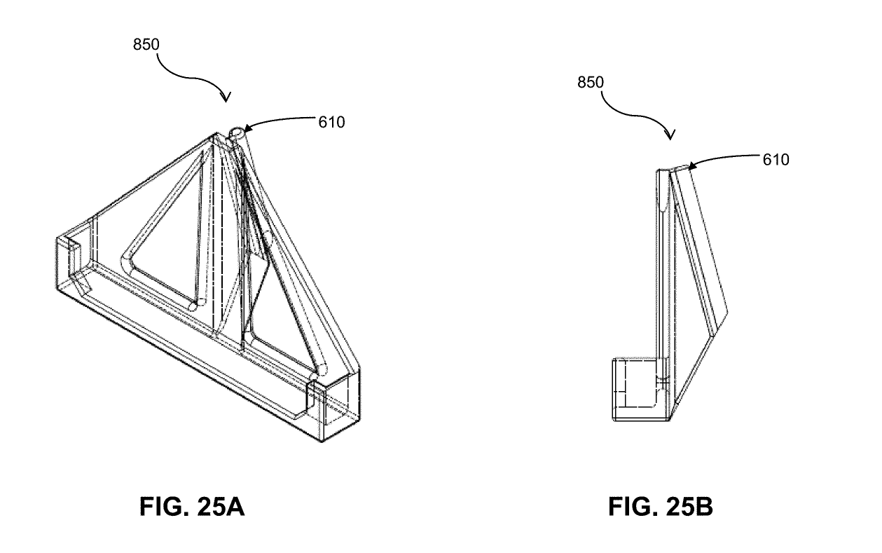

In the embodiment of FIGS. 24A to 24P, the central member 102 is comprised of two opposing pieces, a first opposing portion 140 and a second opposing portion 142, rotatably connected around a pivot point. In this case, the pivot point comprises a pin 144 inserted into a respective pivot slot in both the first opposing portion 140 and the second opposing portion 142. On the opposing side of the first opposing portion 140 and the second opposing portion 142, a locking pin 146 can be removably inserted into a respective pin slot of the first opposing portion 140 and the second opposing portion 142, which forms a ‘closed configuration’. In an embodiment, as shown in FIGS. 24N and 25P, the locking pin 146 can include a locking plate 148 for providing a pushing surface and for restricting movement of the locking pin 146 by limiting movement of the locking plate 148 to a specifically-sized cavity 149. In some cases, the pivot slot and the pin slot can comprise portions of the first opposing portion 140 and the second opposing portion 142 interlaced with each other. As shown in FIGS. 24G to 24M, the locking pin 146 can be removed, or partially removed, to create an opening between the first opposing portion 140 and the second opposing portion 142, which forms an ‘open configuration’. In the open configuration, the pole 52 can be brought into or out of the central channel 104, for mounting and demounting of the hub 2400 respectively. Preferably, the locking pin 146 is biased to retain the hub 2400 in a closed configuration. This can be accomplished, for example, by addition of a spring (not shown) around the locking pin 146 in such a way to urge the locking pin to stay in the pin slot of the first opposing portion 140 and the second opposing portion 142

When the hub 2400 is mounted on the pole 52, in the closed configuration, an externally available tightening fastener 150 is rotated, or otherwise made to move towards the pole 52. In doing so, a moveable ram 152 is driven against the pole 52, causing a clamping action against the opposite side of the central channel 104. In this way, the hub 2400 is secured to the pole 52, preventing the hub 2400 from sliding down the pole even when under the weight of the mountable accessories. In a particular case, a contacting side of the ram 152 can have a concave shape to generally match the shape of the pole 52. In another embodiment, the ram 152 comprises a butt end of the tightening fastener 150.

Advantageously, the use of the ram 152 allows the hub 2400 to be mounted on poles 52 of varying diameters, while maintaining secure mounting to the pole 52. This provides convenience and economic efficiency because a single hub 2400 can be purchased and used with differing stands, as the stands may have varying pole diameters.

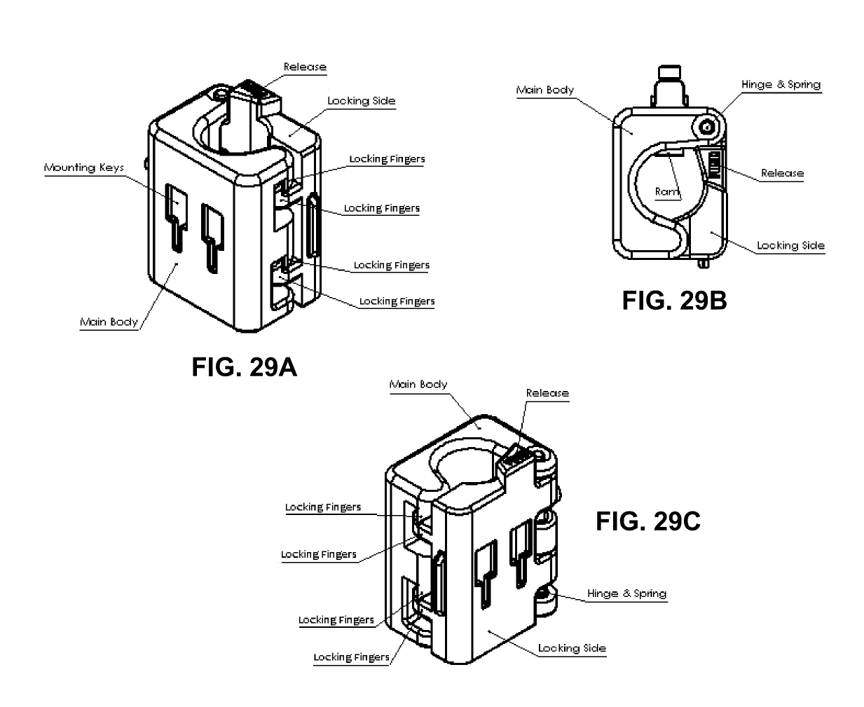

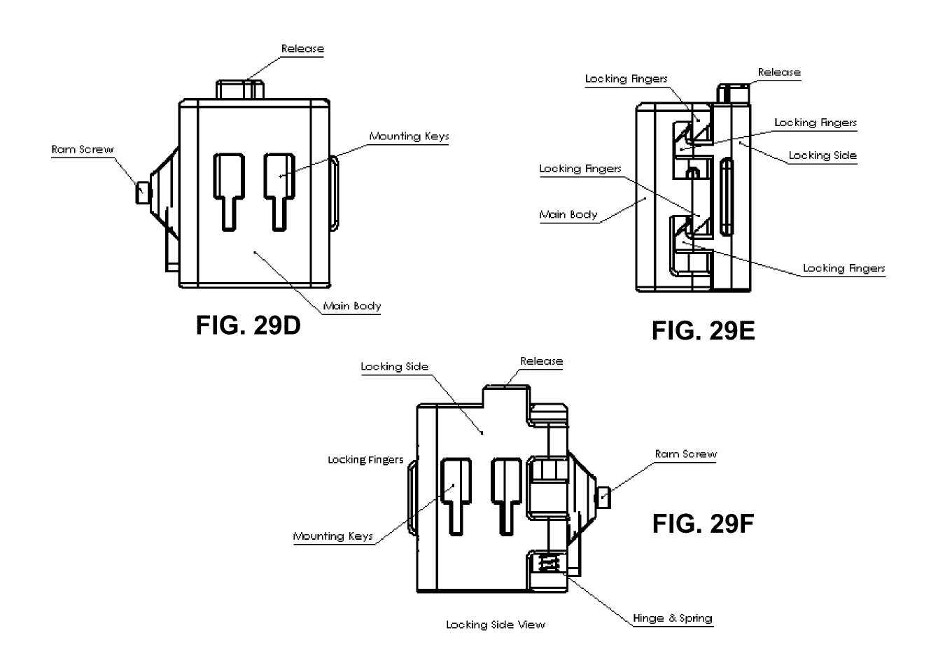

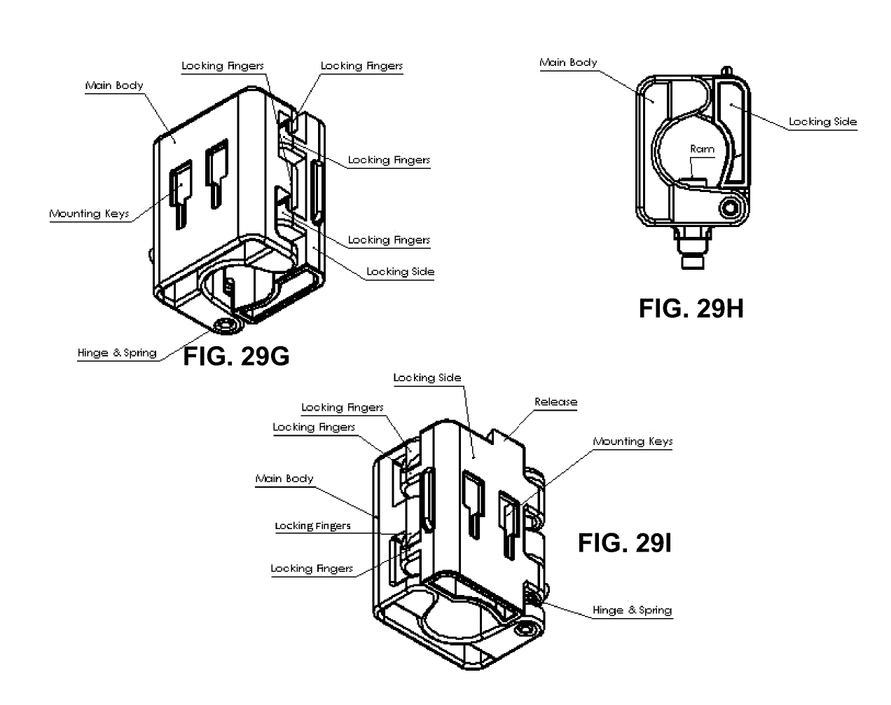

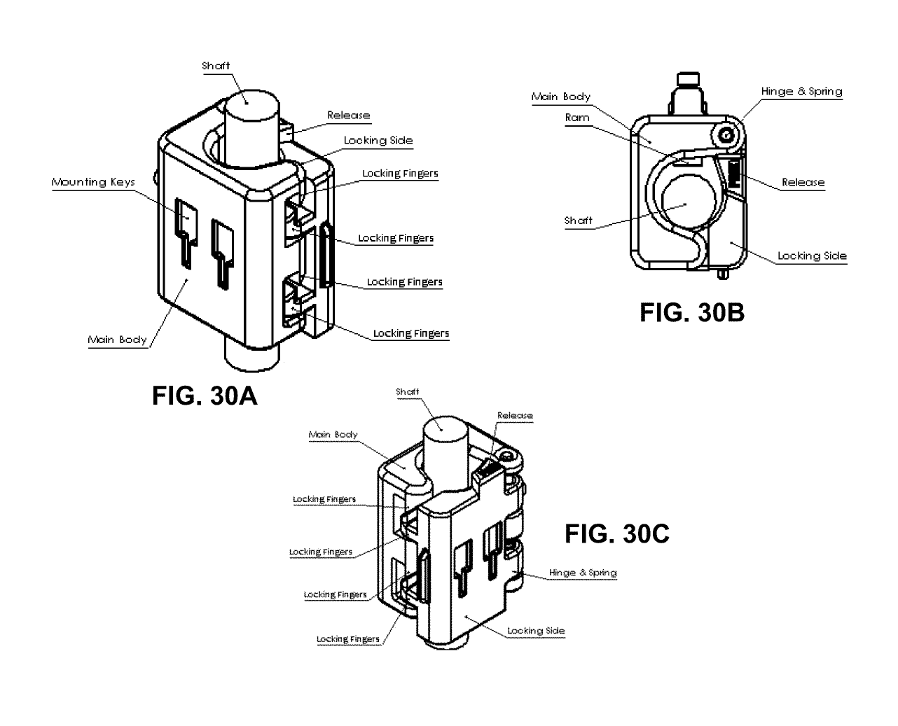

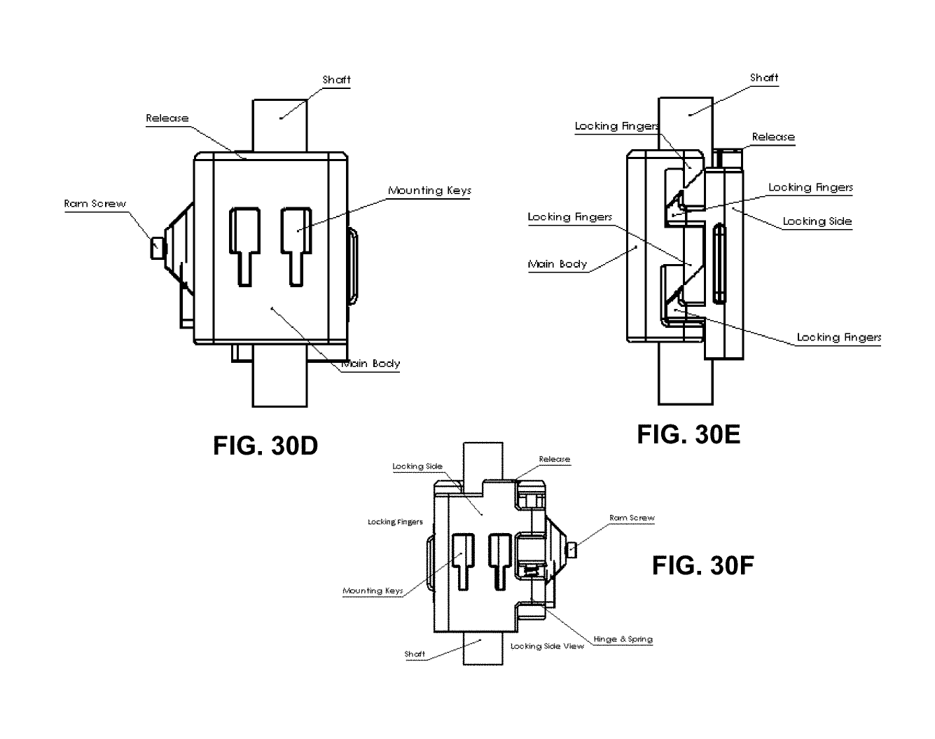

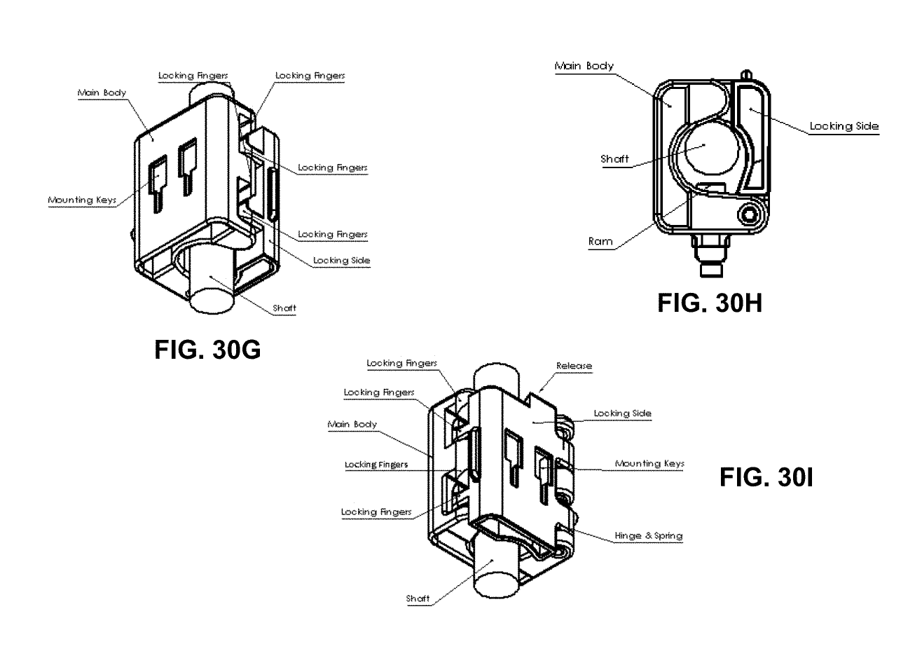

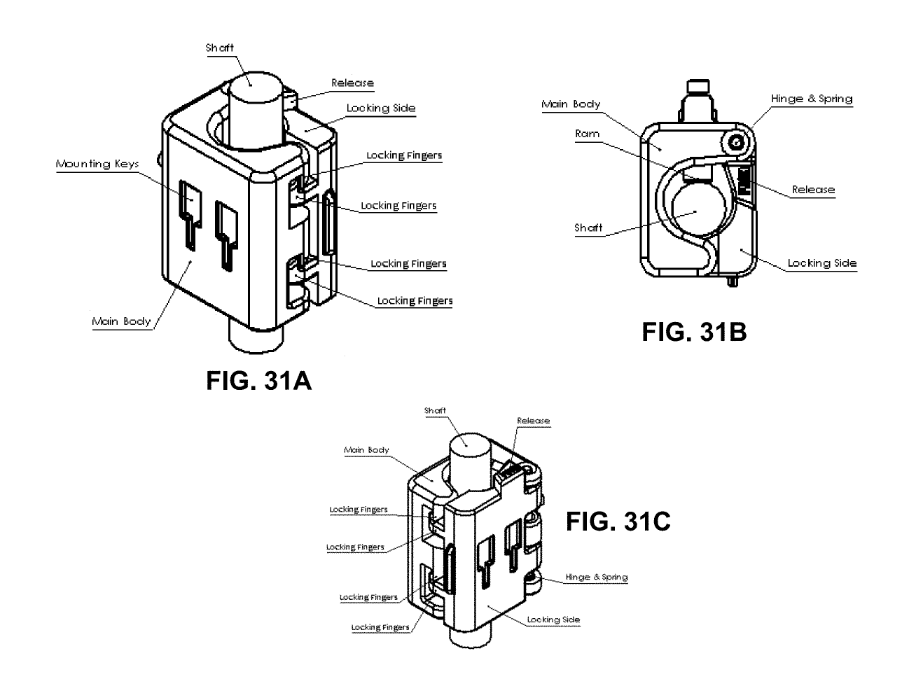

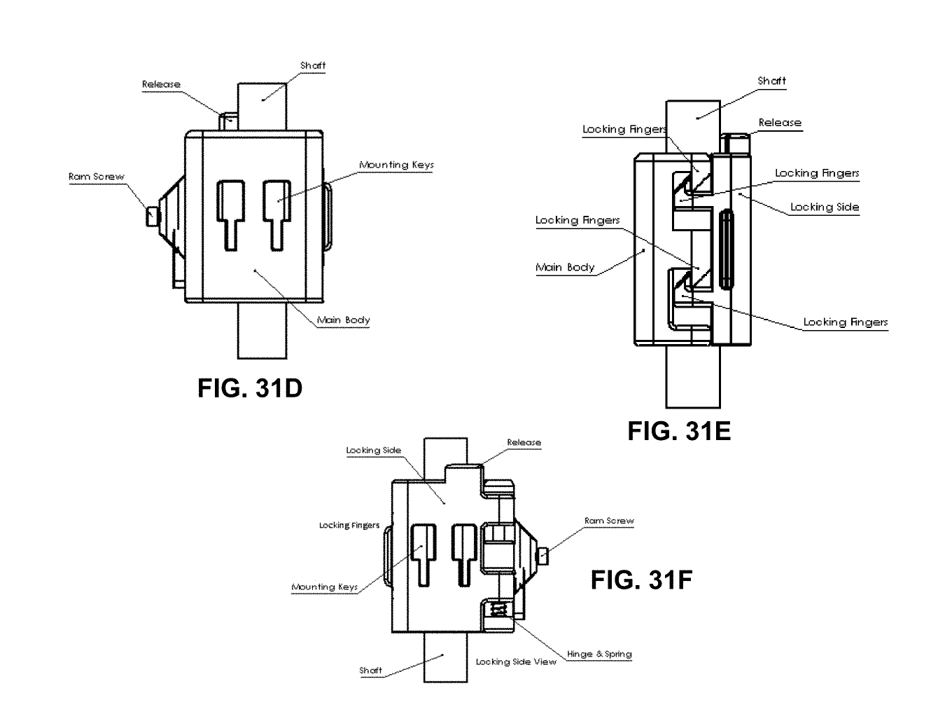

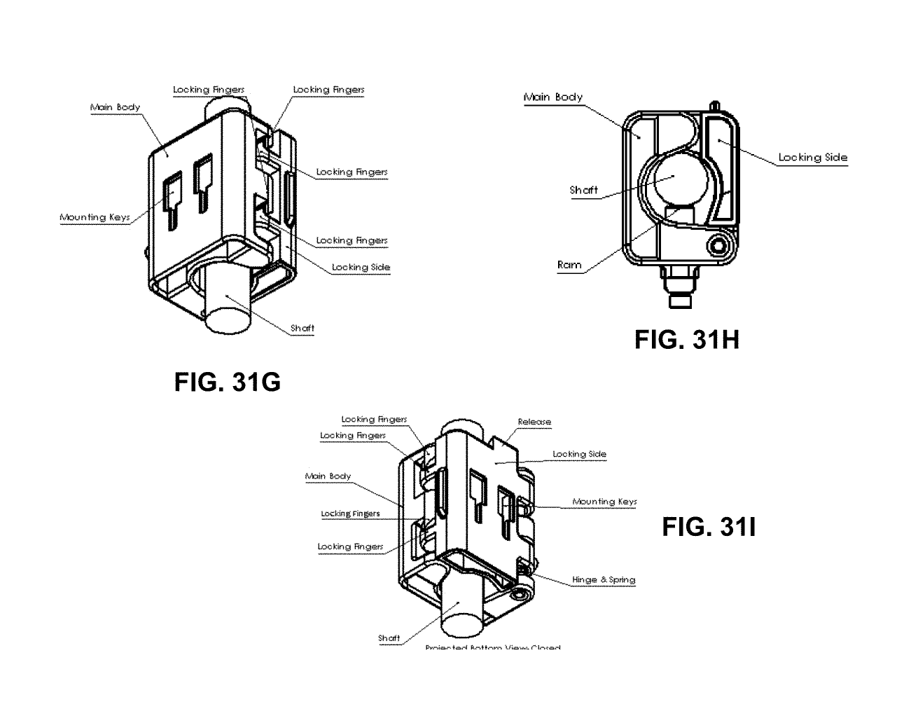

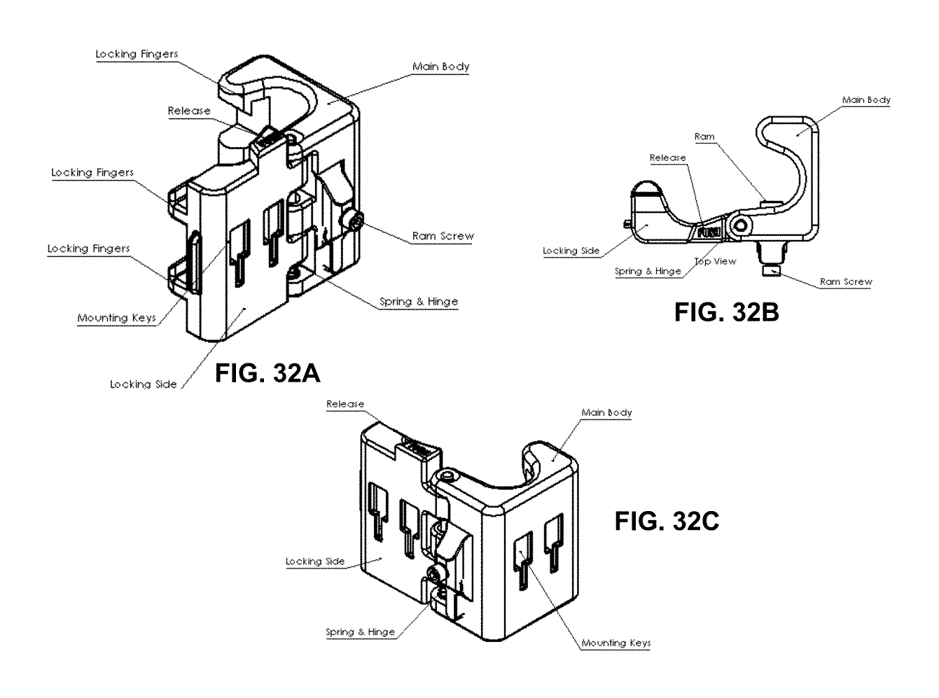

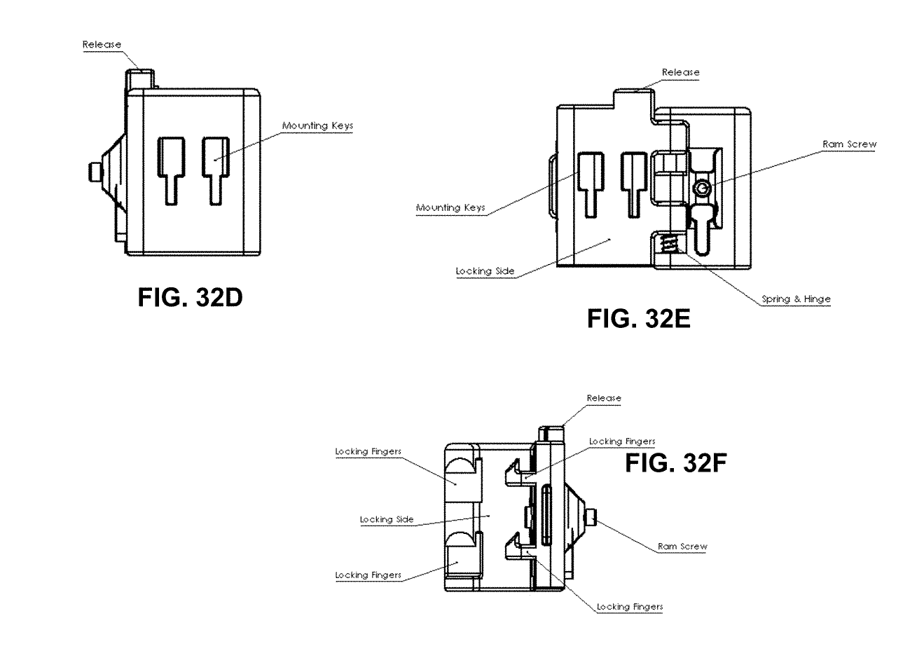

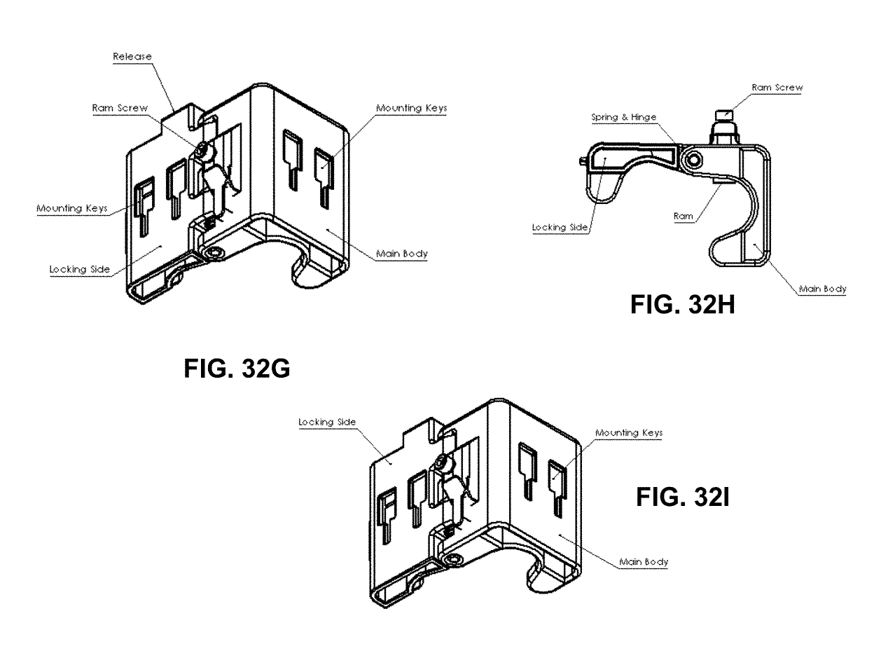

A further embodiment of the hub is shown in FIG. 29A through 32I. In this embodiment, the locking pin from the embodiment shown in FIG. 24A through 25P is replaced by cooperating mating gripping elements on the first opposing portion and second opposing portion. The first opposing portion and the second opposing portion pivot about a pin in the pivot point, as in the embodiment shown in FIG. 24A through 25P, however the hinge of at least one of the first opposing portion and second opposing portion has an empty space along the length of the pin to permit linear disposition of at least one of the first opposing portion and second opposing portion along the pin in the pivot point. When the moveable opposing portion is moved axially along the pin, the mating gripping elements are disengaged permitting the hub to be placed into an open configuration. However, when the moveable opposing portion is aligned to the other opposing portion, and the mating gripping elements are in a closed position, the hub is retained in a closed configuration.

To accomplish this, the pin preferably has a biasing member (such as a spring) disposed therealong to bias the first opposing portion and second opposing portion to a closed configuration, while an external force is required to place the hub in an open configuration. At least one of the first opposing portion and second opposing portion may comprise a release tab to facilitate easily applying such a force so as to displace the movable opposing portion axially along the pin.

The gripping elements are formed along corresponding mating edges of the first opposing portion and second opposing portion. The gripping elements could, for example, be a finger latch (also known as a catch latch, or locking fingers). Such a latch generally comprises a pair of mating fingers whereby the fingers have one angled surface in abutment with each other during closing, to facilitate easy closing as each finger slides along the angled surface of the other to enter a closed position, and a vertical face in abutment with each other in the closed position, which vertical face must be overcome to permit the fingers to be separated, spring pressure is applied through the spring mounted on the hinge pinto prevent accidental opening. In this embodiment, there may also be a ram provided, with the holding force applied by the threaded ram screw, but the locking pin is no longer required.

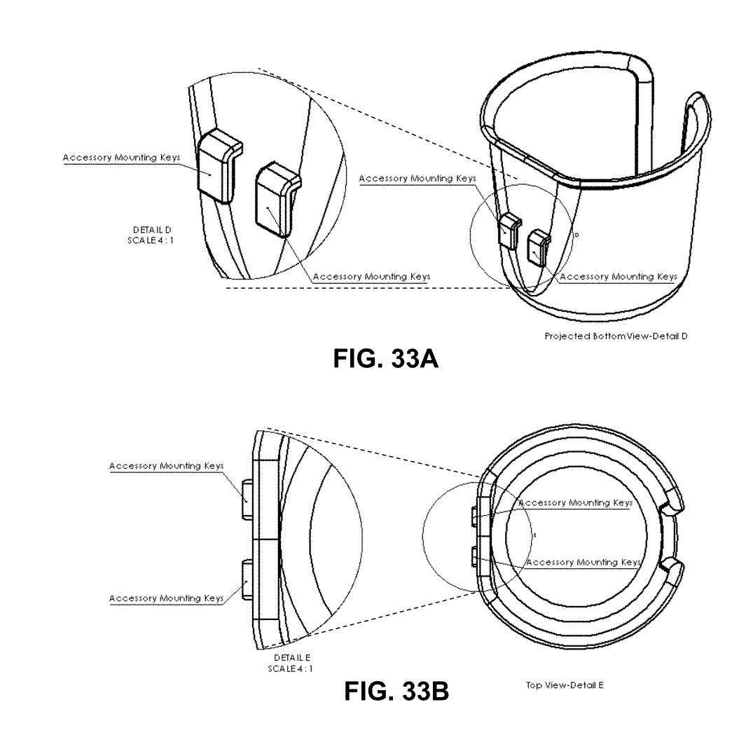

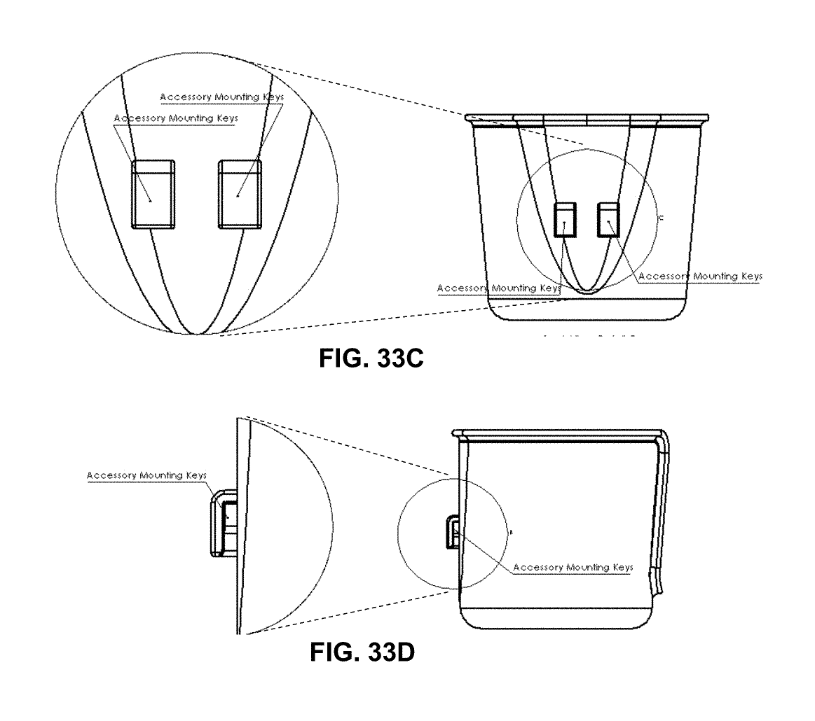

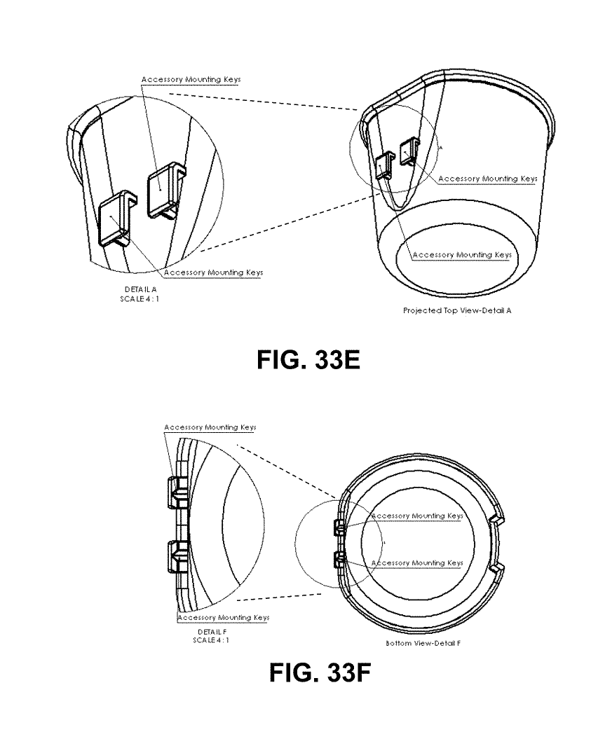

Also as shown in the embodiment of FIG. 29A through 32I is a further embodiment of the mounting slots. In this embodiment, the mounting slots are shown as mounting keys formed as apertures along a surface of the hub. Of course, a plurality of such keys could be provided along various surfaces of the hub. Each mounting key generally comprises an upper wide opening and lower narrow slot. It is not necessary that the mounting keys are accessible from the upper periphery of the hub, as with prior described embodiments. A mating accessory, as shown in FIG. 33A to 33F, has mounting keys that comprise locking tabs which can be accommodated freely within upper wide openings but are snug fit when slid down to the lower narrow slot. The locking tabs have an exposed generally planar face, and an opposing face with a longitudinal protrusion dimensioned to slide within the lower narrow slot of the mounting key of the hub. The accessory shown in FIG. 33A to 33F is a cup holder, however it could be any suitable accessory having the mounting keys disposed thereon.

The hub can have mountable accessories mounted thereon via the one or more mounting slots 110. The mountable accessories can include various supports for items to be accessible by the musician, items to be viewed by the musician, items to be viewed by the audience, or items otherwise accessible during a performance or rehearsal. Examples of mountable accessories with associated supports will be described herein. However, such examples are not intended to be limiting on the type and variety of mountable accessories or associated supports, other than such mountable accessories each having a complementary mounting post as described below. Where the hub has multiple mounting slots 110, more than one of the same mountable accessory, or different mountable accessories, may be mounted on the same hub.

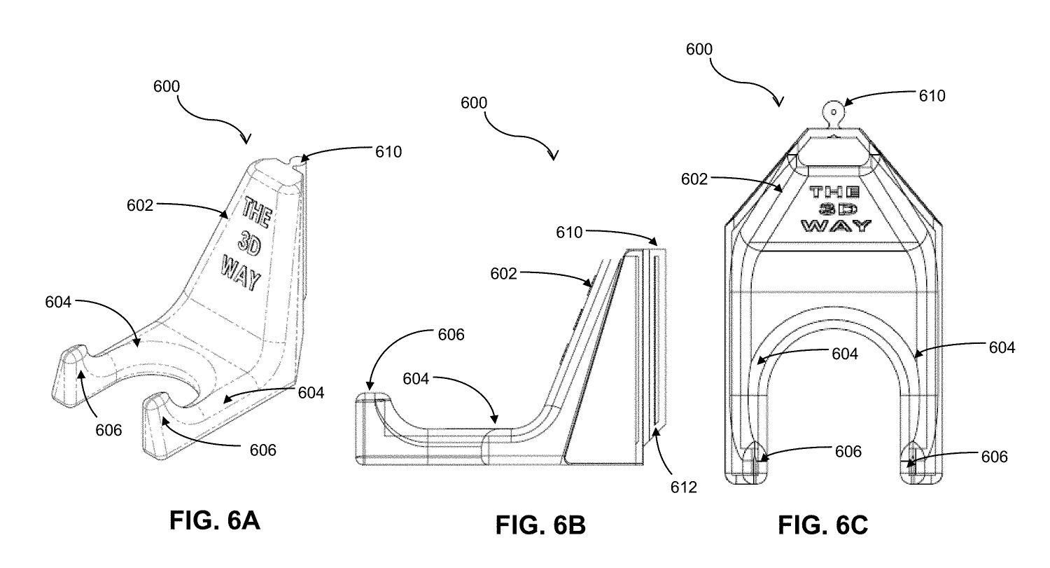

FIGS. 6A to 6C illustrate an example of a mountable accessory being an instrument support 600. The instrument support 600 includes a back portion 602, two horizontal fingers 604 extending from the back portion 602, and an upward lip portion 606 at the end of each finger 604. The fingers 604 define a space therebetween, with an opening opposite the back portion 602, for receiving the instrument. In the case of an appropriately-sized stringed instrument, for example, the neck of the stringed instrument is received between the fingers 604 such that the headstock of the stringed instrument rests on the top of the fingers 604. The instrument support 600 includes a complementary mounting post 610 protruding from the rear of the back portion 602. The complementary mounting post 610 is dimensioned to be received and slid down into one of the mounting slots 110 until the lowermost portion 612 of the complementary mounting post 610 abuts the lower abutment 112. In this way, after the hub has been attached to the pole 52, the musician can then mount the mountable accessory for use by sliding the complementary mounting post 610 into one of the mounting slots 110.

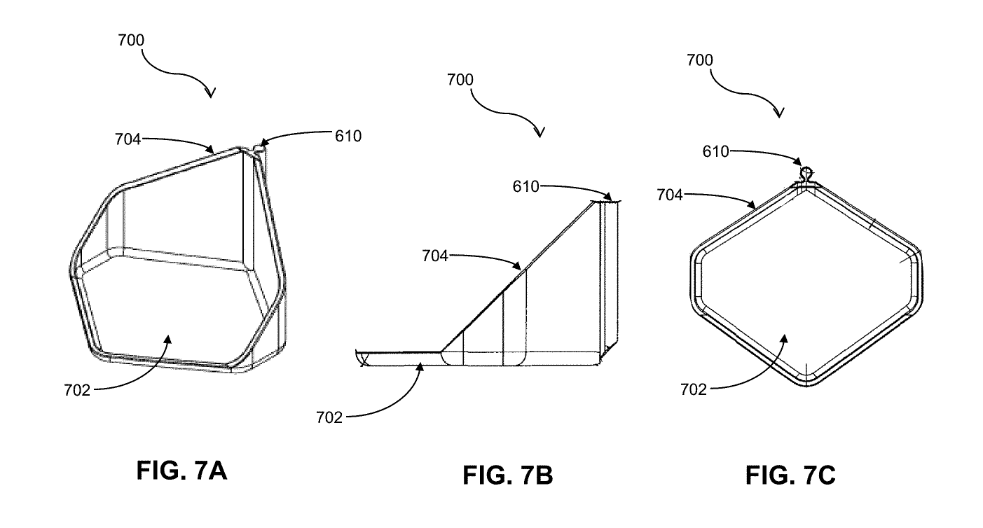

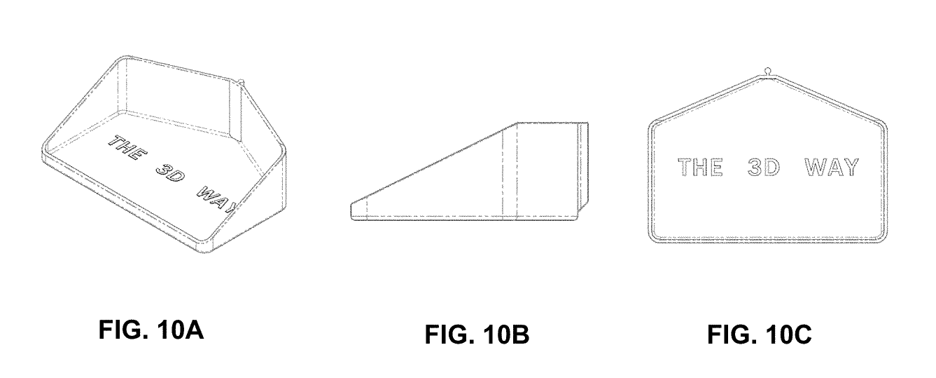

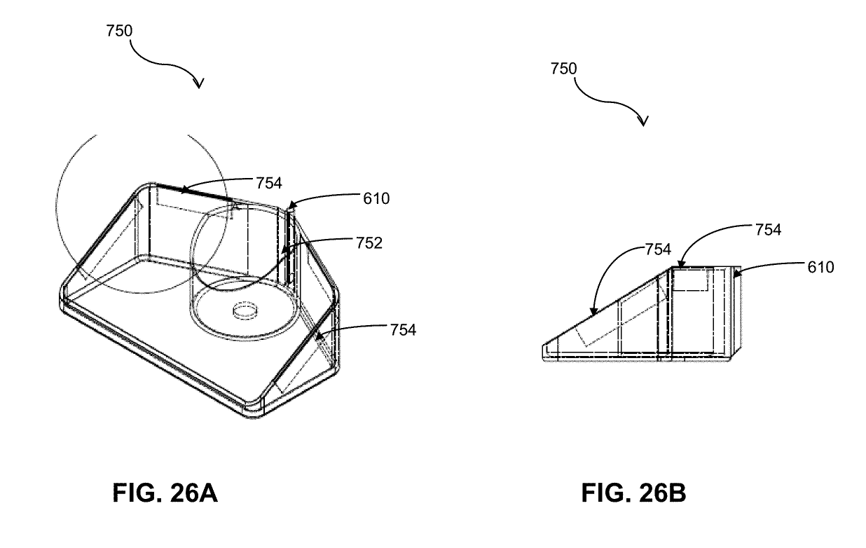

FIGS. 7A to 7C illustrate another example of a mountable accessory being a support tray 700. The support tray 700 can be used to hold various items such as guitar picks, guitar capos, tuners, audience giveaways, or the like. The support tray 700 includes a horizontal floor 702 and a sloped back wall 702 defining a front opening for accessing the horizontal floor 702. Any suitable shape for the floor 702, and any suitable shape and structure for the wall 702, may be used. The support tray 700 includes a complementary mounting post 610, protruding from the rear of the back wall 704, having the same properties as described above. Another example of a mountable accessory being a support tray is shown in FIGS. 10A to 10B. Another example of a mountable accessory being a combination support tray 750, including a drink support 752 and slots 754 (for picks, harmonicas, and the like), is shown in FIGS. 26A and 26B.

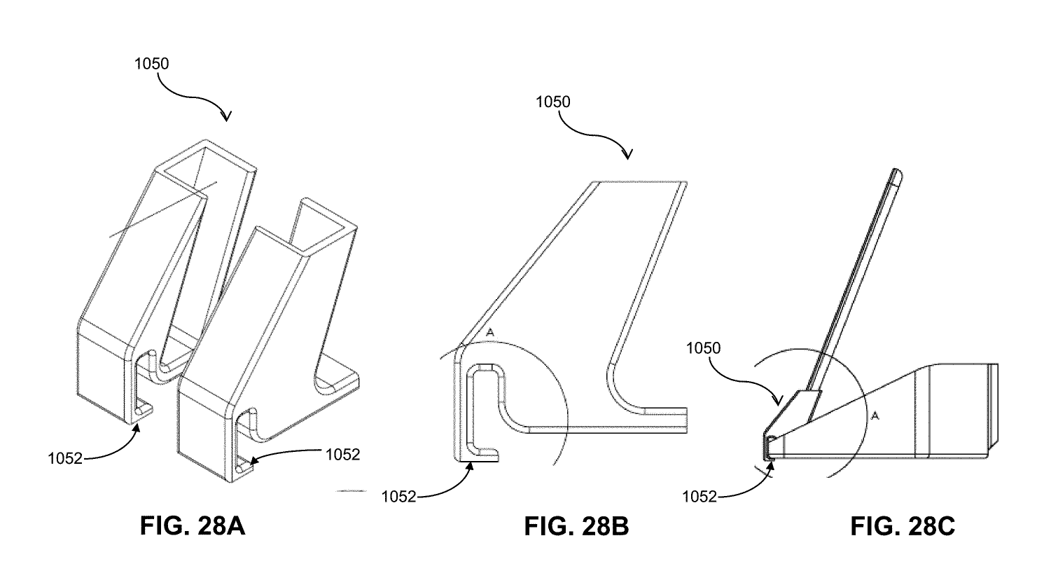

In an embodiment, a removable adapter 1050 can be mounted on the support tray 700. In the example of FIGS. 28A to 28C, two removable adapters 1050 are mounted on the front of the support tray 70 for holding and displaying a flat object, such as a tablet or phone. In this case, the removable adapters 1050 include hooks 1052 which grasp onto the underside of the support tray 70. These adapters 1050 can be placed at different horizontally-spaced distances from each other in order to fit items of varying width. As an example, at a wider distance apart, the adapters 1050 can be used to hold larger items (for example, large computer tablets). When at a smaller distance apart from each other, the adapters 1050 can be used to hold smaller items (for example, cellular phones).

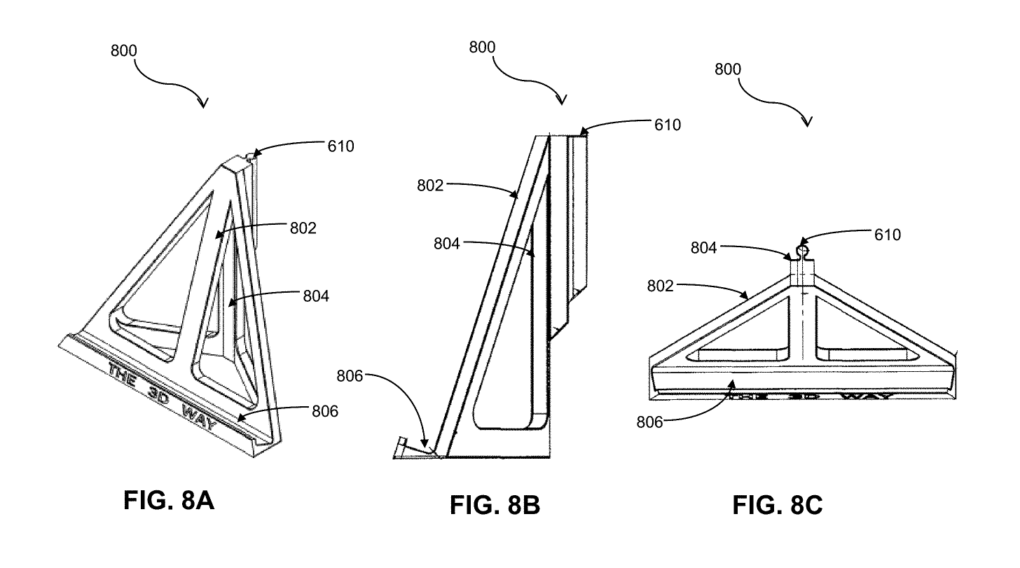

FIGS. 8A to 8C illustrate another example of a mountable accessory being a display support 800. The display support 800 can be used to hold various items to be displayed to the musician; for example, sheet music, a tablet, a lyrics sheet, a set list, or the like. The display support 800 can also be used to hold various items to be displayed to the audience; for example, promotional material, a sign, CDs, records, or the like. The display support 800 includes an angled support portion 802, a back portion 804 connected to the angled support portion 802, and a front lip portion 806 protruding from the bottom of the angled support portion 802. The item to be displayed rests on the front lip portion 806 and leans against the angled support portion 802. For weight reduction, some of the above portions may define cut-away regions therein. The display support 800 includes a complementary mounting post 610, protruding from the rear of the back portion 804, having the same properties as described above.

FIGS. 25A and 25B illustrate another embodiment of a display support 850, including an angled complementary mounting post 610 in order to provide an upward display or support angle.

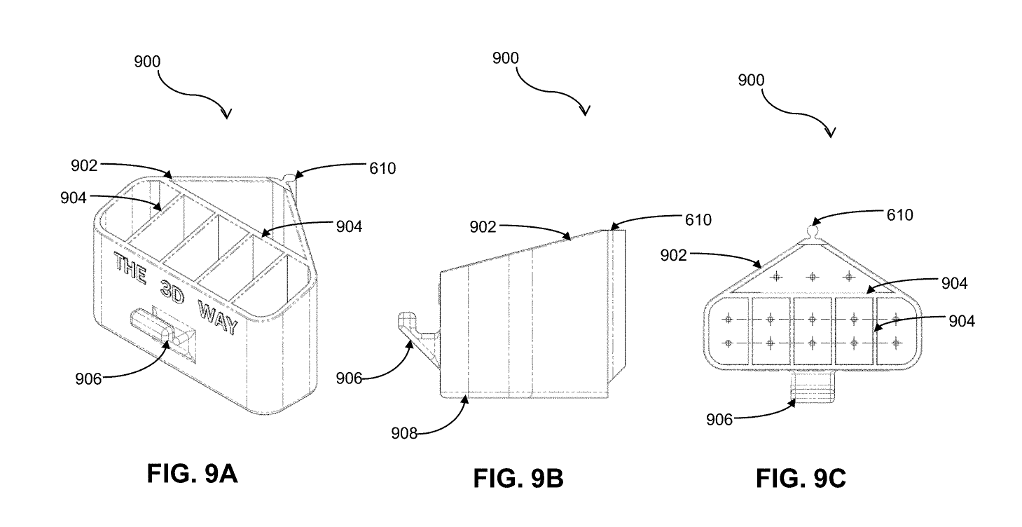

FIGS. 9A to 9C illustrate another example of a mountable accessory being a slotted support 900. The slotted support 900 can be used to hold various items for the musician; for example, harmonicas, pens, guitar slides, earpieces, shakers, cellular phones, or the like. The slotted support 900 includes a peripheral wall 902, a floor 908, and one or more interior walls 904; the peripheral wall 902 and one or more interior walls 904 defining slots therebetween. The peripheral wall 902 can have any suitable shape. The one or more interior walls 904 can be configured in any suitable configuration to define the slots as desired. In this case, the slotted support 900 also includes a front hook 906 protruding from the front of the peripheral wall 902. The front hook 906 can be used, for example, to support a harmonica neck holder, a towel, a tambourine, or the like. The slotted support 900 includes a complementary mounting post 610, protruding from the rear of the peripheral wall 902, having the same properties as described above.

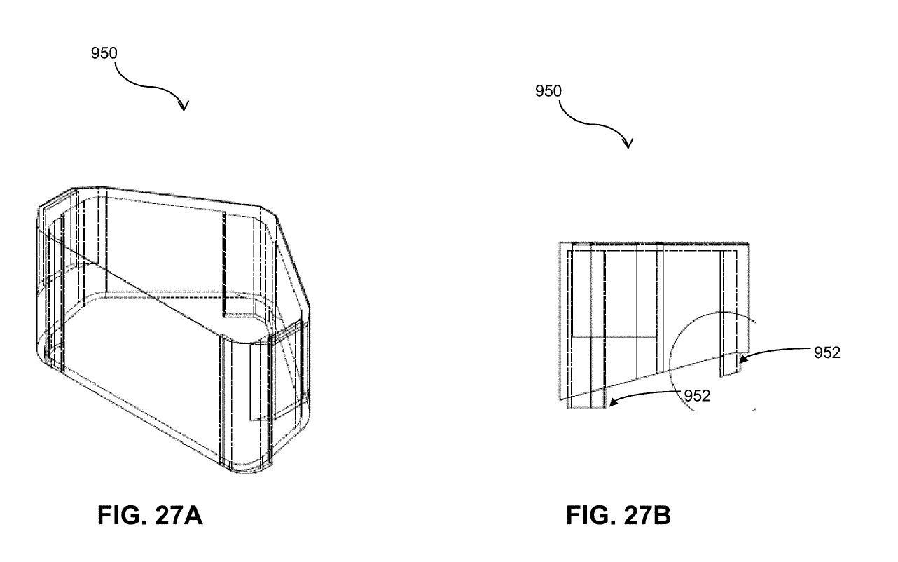

In an embodiment, the slotted support 900 can have a lid 950 mounted thereupon for holding harmonicas and the like. The lid 950 is illustrated in FIGS. 27A and 27B and includes guiding tabs 952 for guiding and securing the lid 950 into position.

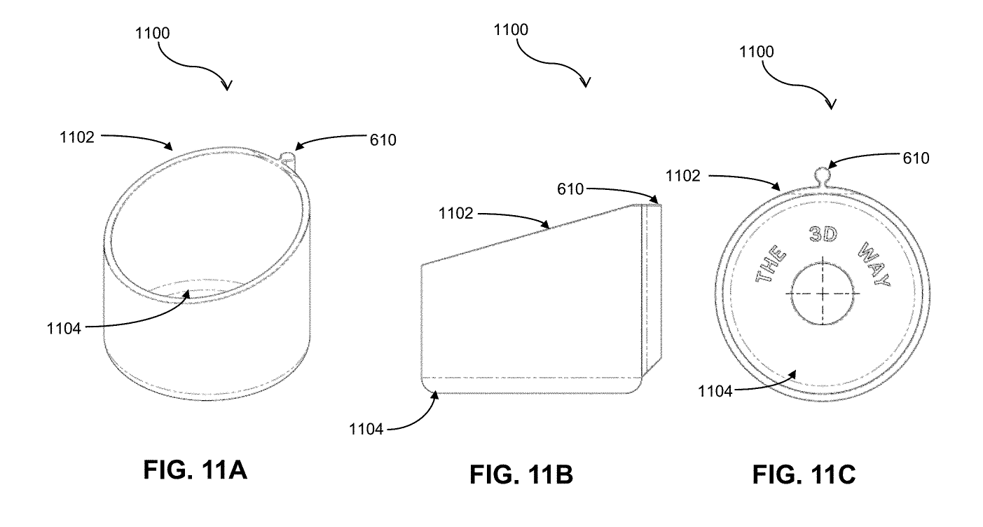

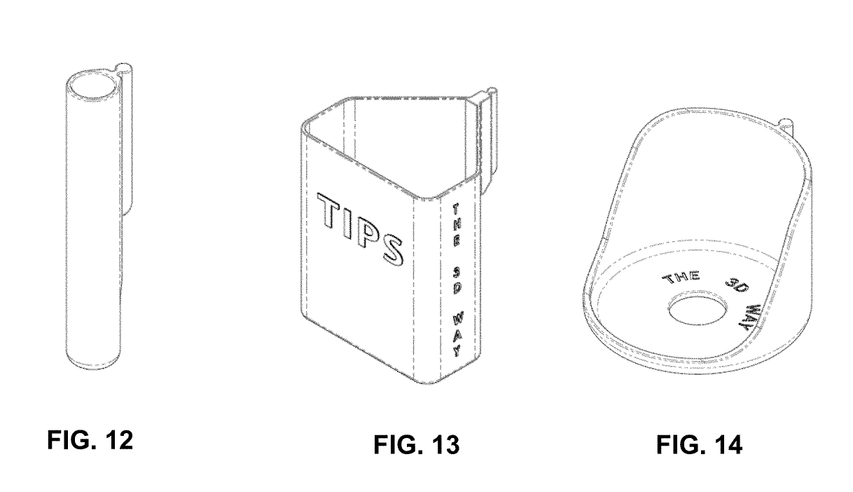

FIGS. 11A to 11C illustrate another example of a mountable accessory being a cupped support 1100. The cupped support 1100 can be used to hold various items for the musician; for example, cups, bottles, tips, whistles, or the like. The cupped support 1100 includes a peripheral wall 1102 and a floor 1104. The peripheral wall 902 can have any suitable shape or configuration. In some cases, the peripheral wall 902 may include an opening. The slotted support 900 includes a complementary mounting post 610, protruding from the rear of the peripheral wall 902, having the same properties as described above. FIGS. 12 to 14 illustrate other examples of a mountable accessory being a cupped support.

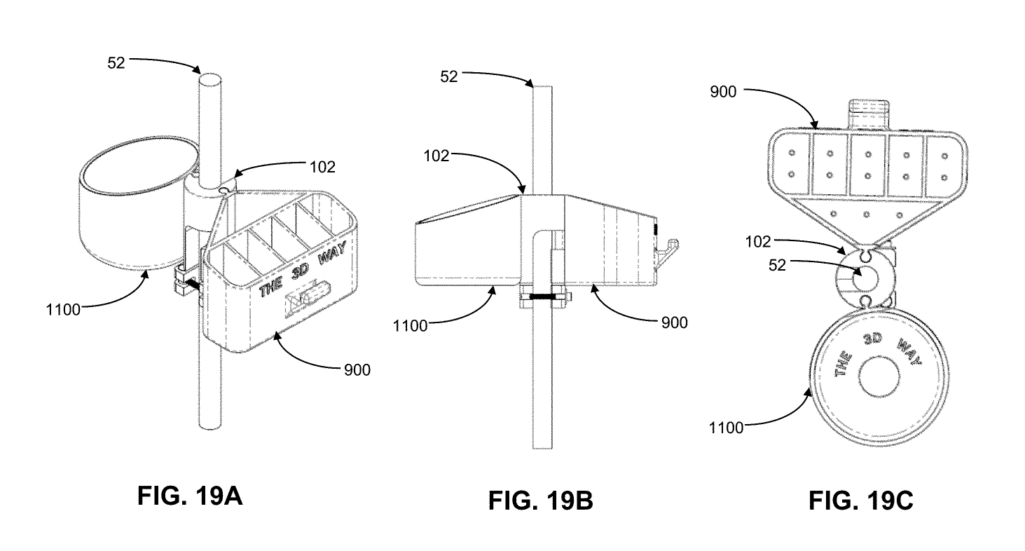

FIGS. 19A to 19C illustrate an example of the hub 1800 with central member 102 mounted on the pole 52 of the stand. The hub 1800 has two mountable accessories, the slotted support 900 and the cupped support 1100, mounted thereon with each of the complementary mounting posts 610 slid into the respective mounting slot 110.

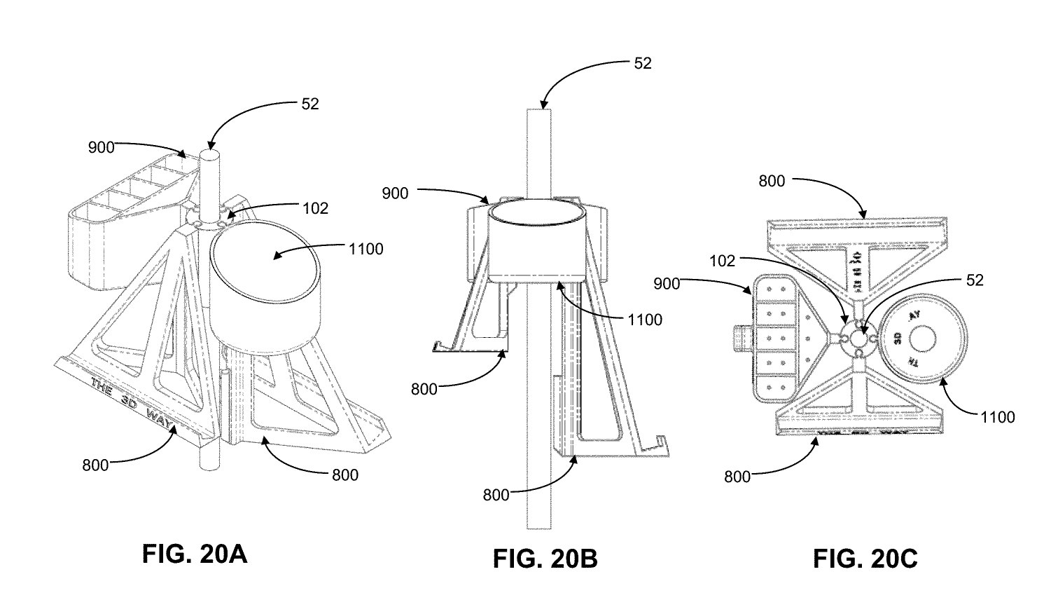

FIGS. 20A to 20C illustrate an example of the hub 500 with central member 102 mounted on the pole 52 of the stand. The hub 500 has four mountable accessories mounted thereon: the slotted support 900, the cupped support 1100, and two of the display supports 800 of varying sizes. The mountable accessories are mounted with each of the complementary mounting posts 610 slid into the respective mounting slot 110.

In some cases, the hub and the mountable accessories are made of a non-conductive durable material, such as plastic. In further cases, some of the elements of the hub and/or the mountable accessories can be made from other materials; for example, the threaded post and the complementary nut can be metal.

In some cases, the mountable accessory may include suitable holes in the bottom or floor in order to allow water or moisture to drain out of the mountable accessory.

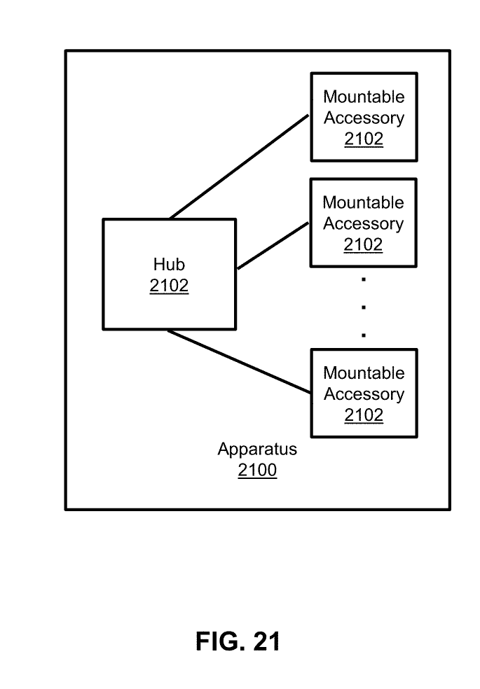

In another embodiment, as shown in FIG. 21, an apparatus 2100 for supporting one or more items onto a stand. The apparatus 2100 includes a hub 2102, according to embodiments described herein, and one or more mountable accessories 2104, according to embodiments described herein. The hub 2102 is mountable to the pole and includes a central member defining a central channel for receiving a pole of the stand. The central member defining one or more mounting slots on a periphery of the central member. The one or more mountable accessories 2104 are each mountable to the hub 2102. Each of the one or more mountable accessories 2104 includes a support, for supporting one or more of the items, and a complementary mounting post affixed to the support. The complementary mounting post dimensioned to be slid in a respective one of the mounting slots.

Other types of mountable accessories, having a complementary mounting post 610, are contemplated as part of the apparatus described herein.

The embodiments described herein have a number of intended advantages. As an example, the hub can easily twist-on or slide-on to various portions of the stand pole, without damaging the stand. The hub and mountable accessories, described herein, allow for the mounting of one or more accessories to be mounted to the hub easily and interchangeably, permitting quick and easy access by the musician without requiring tools or special training. The coaxial hub, as described herein, also allows the center of balance to be closer to the center of balance of the stand, which can eliminate instability that may be present in conventional approaches. In contrast to conventional approaches, the present embodiments can allow the mounting of more than one mountable accessory per hub, providing space and weight savings, and allowing more than one accessory to be within reach or at proper height of the musician or audience.

Although the invention has been described with reference to certain specific embodiments, various modifications thereof will be apparent to those skilled in the art without departing from the spirit and scope of the invention as outlined in the claims appended hereto.

1. An apparatus for supporting one or more items onto a stand, the stand comprising a pole, the apparatus comprising:
a hub mountable to the pole, the hub comprising a central member defining a central channel for receiving the pole, the central member defining one or more mounting slots on a periphery of the central member; and
one or more mountable accessories mountable to the hub, each of the one or more mountable accessories comprising a support, for supporting one or more of the items, and a complementary mounting post affixed to the support, the complementary mounting post dimensioned to be slid into a respective one of the mounting slots.

2. The apparatus of claim 1, wherein the hub is mounted to the pole via openings in the central member to allow the pole access to the central channel.

3. The apparatus of claim 2, wherein the central member defines a transverse opening, upper opening, and lower opening, and wherein the hub is configured to mount on the pole by passing the pole into the transverse opening and rotating the hub such that the pole passes through the upper opening and lower opening into the central channel.

4. The apparatus of claim 3, wherein the transverse opening is from the central channel to the periphery of the central member, an axis of the transverse opening being transverse to the central channel, wherein the upper opening is from the central channel to the periphery of the central member, the upper opening extending from the transverse opening to a top end of the central member, and wherein the lower opening is from the central channel to the periphery of the central member, the lower opening extending from the transverse opening to a bottom end of the central member, access to the lower opening being approximately 180 degrees circumferentially from the upper opening and approximately 90 degrees circumferentially from the transverse opening.

5. The apparatus of claim 1, wherein the hub comprises a first opposing portion pivotally connected to a second opposing portion for closeably exposing the central channel to receive the pole.

6. The apparatus of claim 5, wherein the hub comprises a slidable locking pin for closing the first opposing portion to the second opposing portion opposite the pivot.

7. The apparatus of claim 5, wherein the hub comprises a tightening fastener in mechanical communication with a ram located in the central channel for adjustably securing the hub to the pole.

8. The apparatus of claim 1, wherein the support is selected from a group consisting of an instrument support, a support tray, a display support, a slotted support, and a cupped support.

9. A hub for supporting one or more items onto a stand with one or more mountable accessories, each of the one or more mountable accessories comprising a complementary mounting post affixed to a support, the stand comprising a pole, the hub comprising:
a central member defining a central channel for receiving the pole to mount the hub to the pole; and
one or more mounting slots defined by the central member and located on a periphery of the central member, each of the one or more mounting slots dimensioned to slide a respective one of the complementary mounting posts therein.

10. The hub of claim 9, wherein the hub is mounted to the pole via openings in the central member to allow the pole access to the central channel.

11. The hub of claim 10, wherein the central member defines a transverse opening, upper opening, and lower opening, and wherein the hub is configured to mount on the pole by passing the pole into the transverse opening and rotating the hub such that the pole passes through the upper opening and lower opening into the central channel.

12. The hub of claim 11, wherein the transverse opening is from the central channel to the periphery of the central member, an axis of the transverse opening being transverse to the central channel, wherein the upper opening is from the central channel to the periphery of the central member, the upper opening extending from the transverse opening to a top end of the central member, and wherein the lower opening is from the central channel to the periphery of the central member, the lower opening extending from the transverse opening to a bottom end of the central member, access to the lower opening being approximately 180 degrees circumferentially from the upper opening and approximately 90 degrees circumferentially from the transverse opening.

13. The hub of claim 12, wherein the transition from the central channel to the upper opening, lower opening, or both, is tapered for snapping the pole into the central channel.

14. The hub of claim 9, wherein the hub comprises a first opposing portion pivotally connected to a second opposing portion for closeably exposing the central channel to receive the pole.

15. The hub of claim 9, wherein the hub comprises a slidable locking pin for closing the first opposing portion to the second opposing portion opposite the pivot.

16. The hub of claim 15, wherein the hub comprises a tightening fastener in mechanical communication with a ram located in the central channel for adjustably securing the hub to the pole.

17. The hub of claim 15, wherein the central member defines a plurality of mounting slots.

18. The hub of claim 17, wherein the plurality of mounting slots are spaced annularly around the periphery of the central member.

19. A mountable accessory for supporting one or more items onto a stand with a hub, the stand comprising a pole, the hub mountable to the pole, the hub comprising a central member defining one or more mounting slots on a periphery of the central member, the mountable accessory comprising:
a support, for supporting one or more of the items; and
a complementary mounting post affixed to a rear of the support, the complementary mounting post dimensioned to be slid into a respective one of the mounting slots.

20. The mountable accessory of claim 19, wherein the support is selected from a group consisting of an instrument support, a support tray, a display support, a slotted support, and a cupped support.
